(19) United States
(12) Patent Application Publication
(10) Pub. No.: US 2023/0284277 A1
(43) Pub. Date: Sep. 7, 2023

(54) METHOD FOR TRANSMITTING RACH ON BASIS OF POLARIZATION INFORMATION BY TERMINAL IN WIRELESS COMMUNICATION SYSTEM, AND DEVICE THEREFOR

(71) Applicant: LG ELECTRONICS INC., Seoul (KR)

(72) Inventors: Haewook PARK, Seoul (KR); Suckchel YANG, Seoul (KR); Seonwook KIM, Seoul (KR); Hyunsoo KO, Seoul (KR)

(21) Appl. No.: 18/018,396

(22) PCT Filed: Aug. 4, 2021
(86) PCT No.: PCT/KR2021/010228

§ 371 Date: Jan. 27, 2023

(30) Foreign Application Priority Data
Aug. 4, 2020 (KR) 10-2020-0097135
May 12, 2021 (KR) 10-2021-0061077

(51) Int. Cl. H04W 74/08

(52) U.S. Cl. CPC H04W 74/0833

(57) ABSTRACT

According to various embodiments, disclosed are a method for transmitting a random access channel (RACH) on the basis of polarization information by a terminal in a wireless communication system, and a device therefor. Particularly, the method comprises the steps of: receiving a synchronization signal block (SSB); determining a RACH occasion on the basis of the SSB; and transmitting the RACH in the RACH occasion, wherein the terminal obtains the polarization information relating to the RACH on the basis of the index of the SSB, and transmits the RACH having the polarization information.

### TECHNICAL FIELD

The present disclosure relates to a method of transmitting a random access channel (RACH) based on polarization information in a wireless communication system and apparatus therefor.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR).

### DISCLOSURE

### Technical Problem

The object of the present disclosure is to provide a method and apparatus for performing an efficient random access channel (RACH) procedure based on a mapping relationship between a synchronization signal block (SSB) and polarization.

It will be appreciated by those of ordinary skill in the art to which the embodiment(s) pertain that the objects that could be achieved with the embodiment(s) are not limited to what has been particularly described hereinabove and the above and other objects will be more clearly understood from the following detailed description.

### Technical Solution

In an aspect of the present disclosure, there is provided a method of transmitting, by a user equipment (UE), a random access channel (RACH) based on polarization information. The method may include: receiving a synchronization signal block (SSB); determining a RACH occasion based on the SSB; and transmitting the RACH on the RACH occasion. The UE may be configured to obtain the polarization information related to the RACH based on an index of the SSB and transmit the RACH with the polarization information.

Alternatively, the polarization information may include information on right-handed circular polarization (RHCP) or left-handed circular polarization (LHCP). A preamble sequence pool for the RACH occasion may be configured to be identical for the RHCP and the LHCP.

Alternatively, the UE may be configured to: receive a random access response (RAR) in response to the RACH; obtain the polarization information related to the RAR based on a random access preamble identifier (RAPID) included in the RAR; and determine whether the RAR is a response to the RACH, based on the obtained polarization information.

Alternatively, the UE may be configured to receive an RAR in response to the RACH. A RAPID included in the RAR may further include an identifier for identifying the polarization information.

Alternatively, the polarization information may include information on RHCP or LHCP. The RAPID may be pre-mapped for each of RHCP and LHCP.

Alternatively, the UE may be configured to receive an RAR in response to the RACH only in a polarization direction corresponding to the polarization information related to the SSB.

Alternatively, the UE may be configured to: map SSB indices to preamble sequence indices and polarization indices related to the polarization information based on a preconfigured mapping order; and obtain a preamble sequence index and a polarization index related to the index of the SSB based on mapping results.

Alternatively, the SSB indices may be first mapped to the preamble sequence indices within one RACH occasion based on the preconfigured mapping order.

Alternatively, the SSB indices may be first mapped to the polarization indices within one RACH occasion based on the preconfigured mapping order.

Alternatively, the SSB indices may be first mapped to the polarization indices for one preamble sequence index and then mapped to the preamble sequence indices within one RACH occasion based on the preconfigured mapping order.

In another aspect of the present disclosure, there is provided a method of receiving, by a non-terrestrial network (NTN), a RACH based on polarization information in a wireless communication system. The method may include: transmitting an SSB; and receiving the RACH on a RACH occasion related to the SSB. The RACH may be received based on the RACH occasion and the polarization information related to an index of the SSB.

In another aspect of the present disclosure, there is provided a UE configured to transmit a RACH based on polarization information in a wireless communication system. The UE may include: a radio frequency (RF) transceiver; and a processor connected to the RF transceiver. The processor may be configured to: control the RF transceiver to receive an SSB; determine a RACH occasion based on the SSB; obtain the polarization information on the RACH based on an index of the SSB; and transmit the RACH with the polarization information.

In another aspect of the present disclosure, there is provided a chipset configured to transmit a RACH based on polarization information in a wireless communication system. The chipset may include: at least one processor; and at least one memory operably connected to the at least one processor and configured to, when executed, cause the at least one processor to perform operations. The operations may include: receiving an SSB; determining a RACH occasion based on the SSB; obtaining the polarization information on the RACH based on an index of the SSB; and transmitting the RACH with the polarization information.

In a further aspect of the present disclosure, there is provided a computer-readable storage medium including at least one computer program configured to perform operations to transmit a RACH based on polarization information in a wireless communication system. The at least one computer program may be configured to cause at least one processor to perform the operations to transmit the RACH, and the at least one computer program may be stored on the computer-readable storage medium. The operations may include: receiving an SSB; determining a RACH occasion based on the SSB; obtaining the polarization information on the RACH based on an index of the SSB; and transmitting the RACH with the polarization information.

### Advantageous Effects

According to various embodiments, a random access channel (RACH) procedure may be efficiently performed based on a mapping relationship between a synchronization signal block (SSB) and polarization.

Effects to be achieved by embodiment(s) are not limited to what has been particularly described hereinabove and other effects not mentioned herein will be more clearly understood by persons skilled in the art to which embodiment(s) pertain from the following detailed description.

### DESCRIPTION OF DRAWINGS

The accompanying drawings, which are included to provide a further understanding of the present disclosure, illustrate embodiments of the disclosure and together with the description serve to explain the principle of the present disclosure.

FIG. 1 illustrates the structure of an LTE system to which embodiment(s) are applicable.

FIG. 2 illustrates the structure of an NR system to which embodiment(s) are applicable.

FIG. 3 illustrates the structure of an NR radio frame to which embodiment(s) are applicable.

FIG. 4 illustrates the slot structure of an NR frame to which embodiment(s) are applicable.

FIG. 5 illustrates a procedure in which a base station transmits a downlink signal to a UE.

FIG. 6 illustrates a procedure in which a UE transmits an uplink signal to a base station.

FIG. 7 illustrates an example of time domain resource allocation for a PDSCH by a PDCCH and an example of time domain resource allocation for a PUSCH by a PDCCH.

FIG. 8 is a diagram for explaining HARQ-ACK operation for a user equipment (UE) to report control information.

FIG. 9 is a diagram for explaining a random access procedure.

FIG. 10 illustrates a non-terrestrial network (NTN).

FIG. 11 illustrates an overview and a scenario of an NTN.

FIG. 12 illustrates TA components of the NTN.

FIGS. 13 and 14 are diagrams for explaining polarization of an antenna.

FIG. 15 is a diagram for explaining a scenario related to polarization reuse

FIG. 16 is a diagram for explaining a method of matching a synchronization signal block (SSB) and a random access channel (RACH) occasion (RO) based on circular polarization.

FIG. 17 is a flowchart illustrating a method for a UE to perform a UL transmission operation based on embodiments.

FIG. 18 is a flowchart illustrating a method for a UE to perform a DL reception operation based on embodiments.

FIG. 19 is a flowchart illustrating a method for a BS to perform a UL reception operation based on embodiments.

FIG. 20 is a flowchart illustrating a method for a BS to perform a DL transmission operation based on embodiments.

FIGS. 21 and 22 are flowcharts illustrating methods of performing signaling between a BS and a UE based on embodiments.

FIG. 23 is a diagram for explaining a method for a UE to transmit an RACH in consideration of circular polarization.

FIG. 24 is a diagram for explaining a method for an NTN to receive a RACH in consideration of circular polarization.

FIG. 25 illustrates a communication system applied to the present disclosure.

FIG. 26 illustrates wireless devices applicable to the present disclosure.

FIG. 27 illustrates another example of a wireless device to which the present disclosure is applied.

### DETAILED DESCRIPTION

The wireless communication system is a multiple access system that supports communication with multiple users by sharing available system resources (e.g., bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency (SC-FDMA) system, a multi carrier frequency division multiple access (MC-FDMA) system, and the like.

A sidelink refers to a communication scheme in which a direct link is established between user equipments (UEs) to directly exchange voice or data between UEs without assistance from a base station (BS). The sidelink is being considered as one way to address the burden on the BS caused by rapidly increasing data traffic.

Vehicle-to-everything (V2X) refers to a communication technology for exchanging information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive MTC, and Ultra-Reliable and Low Latency Communication (URLLC) may be referred to as new radio access technology (RAT) or new radio (NR). Even in NR, V2X communication may be supported.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

5G NR is a successor technology of LTE-A, and is a new clean-slate mobile communication system with characteristics such as high performance, low latency, and high availability. 5G NR may utilize all available spectrum resources, from low frequency bands below 1 GHz to intermediate frequency bands from 1 GHz to 10 GHz and high frequency (millimeter wave) bands above 24 GHz.

For clarity of explanation, LTE-A or 5G NR is mainly described, but the technical spirit of the embodiment(s) is not limited thereto

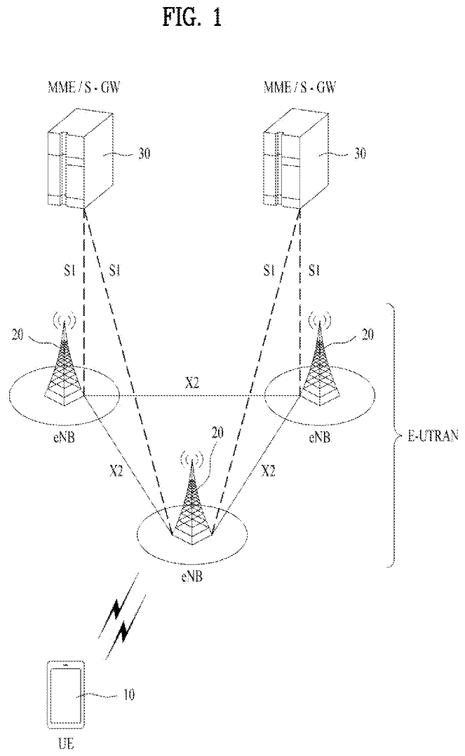

FIG. 1 illustrates the structure of an LTE system to which the present disclosure is applicable. This may also be called an evolved UMTS terrestrial radio access network (E-UTRAN) or LTE/LTE-A system.

Referring to FIG. 1, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

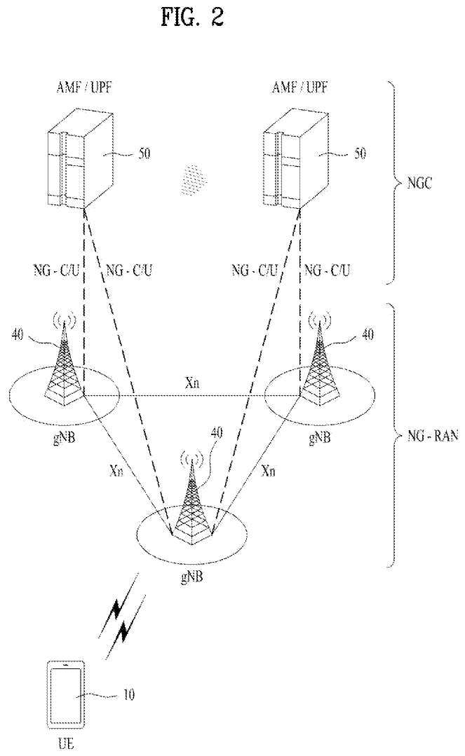

FIG. 2 illustrates the structure of a NR system to which the present disclosure is applicable.

Referring to FIG. 2, a next generation radio access network (NG-RAN) may include a next generation Node B (gNB) and/or an eNB, which provides user-plane and control-plane protocol termination to a UE. In FIG. 2, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

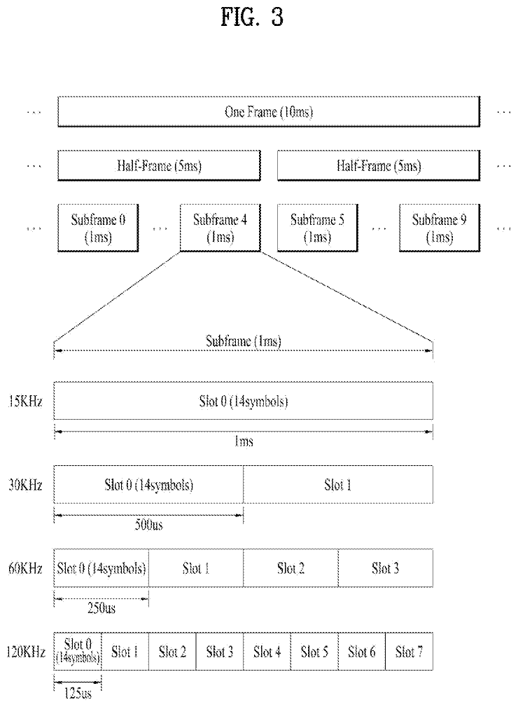

FIG. 3 illustrates the structure of a NR radio frame to which the present disclosure is applicable.

Referring to FIG. 3, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM(A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot N^{slot}_{symb}, the number of slots per frame N^{frame,u}ₛₗₒₜ, and the number of slots per subframe N^{subframe,u}ₛₗₒₜ according to an SCS configuration μ in the NCP case.

TABLE 1

| SCS (15*2u) | N^{slot}_{symb} | N^{frame, u}ₛₗₒₜ | N^{subframe, u}ₛₗₒₜ |
|---|---|---|---|
| 15 kHz (u = 0) | 14 | 10 | 1 |
| 30 kHz (u = 1) | 14 | 20 | 2 |
| 60 kHz (u = 2) | 14 | 40 | 4 |
| 120 kHz (u = 3) | 14 | 80 | 8 |
| 240 kHz (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 kHz (u = 2) | 12 | 40 | 4 |

In the NR system, different OFDM(A) numerologies (e.g., SCSs, CP lengths, etc.) may be configured for a plurality of cells aggregated for one UE. Thus, the (absolute) duration of a time resource (e.g., SF, slot, or TTI) including the same number of symbols may differ between the aggregated cells (such a time resource is commonly referred to as a time unit (TU) for convenience of description).

In NR, multiple numerologies or SCSs to support various 5G services may be supported. For example, a wide area in conventional cellular bands may be supported when the SCS is 15 kHz, and a dense urban environment, lower latency, and a wider carrier bandwidth may be supported when the SCS is 30 kHz/60 kHz. When the SCS is 60 kHz or higher, a bandwidth wider than 24.25 GHz may be supported to overcome phase noise.

The NR frequency band may be defined as two types of frequency ranges. The two types of frequency ranges may be FR1 and FR2. The numerical values of the frequency ranges may be changed. For example, the two types of frequency ranges may be configured as shown in Table 3 below. Among the frequency ranges used in the NR system, FR1 may represent “sub 6 GHz range” and FR2 may represent “above 6 GHz range” and may be called millimeter wave (mmW).

TABLE 3

| Frequency Range | Corresponding | Subcarrier Spacing |
|---|---|---|
| designation | frequency range | (SCS) |
| FR1 | 450 MHz-6000 MHz | 15, 30, 60 kHz |
| FR2 | 24250 MHz-52600 MHz | 60, 120, 240 kHz |

As mentioned above, the numerical values of the frequency ranges of the NR system may be changed. For example, FR1 may include a band of 410 MHz to 7125 MHz as shown in Table 4 below. That is, FR1 may include a frequency band of 6 GHz (or 5850 MHz, 5900 MHz, 5925 MHz, etc.) or higher. For example, the frequency band of 6 GHz (or 5850 MHz, 5900 MHz, 5925 MHz, etc.) or higher included in FR1 may include an unlicensed band. The unlicensed band may be used for various purposes, for example, for communication for vehicles (e.g., autonomous driving).

TABLE 4

| Frequency Range | Corresponding | Subcarrier Spacing |
|---|---|---|
| designation | frequency range | (SCS) |
| FR1 | 410 MHz-7125 MHz | 15, 30, 60 kHz |
| FR2 | 24250 MHz-52600 MHz | 60, 120, 240 kHz |

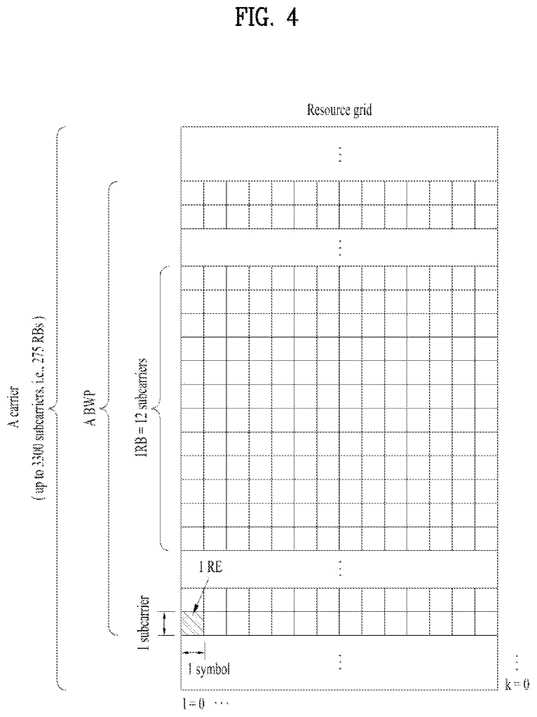

FIG. 4 illustrates the slot structure of a NR frame.

Referring to FIG. 4, one slot includes a plurality of symbols in the time domain. For example, one slot may include 14 symbols in a normal CP and 12 symbols in an extended CP. Alternatively, one slot may include 7 symbols in the normal CP and 6 symbols in the extended CP.

A carrier may include a plurality of subcarriers in the frequency domain. A resource block (RB) is defined as a plurality of consecutive subcarriers (e.g., 12 subcarriers) in the frequency domain. A bandwidth part (BWP) may be defined as a plurality of consecutive (P)RBs in the frequency domain, and the BWP may correspond to one numerology (e.g., SCS, CP length, etc.). The carrier may include up to N (e.g., 5) BWPs. Data communication may be conducted in an activated BWP. In a resource grid, each element may be referred to as a resource element (RE) and may be mapped to one complex symbol.

The wireless interface between UEs or the wireless interface between a UE and a network may be composed of an L1 layer, an L2 layer, and an L3 layer. In various embodiments of the present disclosure, the L1 layer may represent a physical layer. The L2 layer may represent, for example, at least one of a MAC layer, an RLC layer, a PDCP layer, and an SDAP layer. The L3 layer may represent, for example, an RRC layer.

Bandwidth Part (BWP)

In the NR system, up to 400 MHz may be supported per component carrier (CC). If a UE operating on a wideband CC always operates with the RF for the entire CCs turned on, the battery consumption of the UE may be increased. Alternatively, considering various use cases (e.g., eMBB, URLLC, mMTC, V2X, etc.) operating within one wideband CC, different numerologies (e.g., sub-carrier spacings) may be supported for different frequency bands within a specific CC. Alternatively, the capability for the maximum bandwidth may differ among the UEs. In consideration of this, the BS may instruct the UE to operate only in a partial bandwidth, not the entire bandwidth of the wideband CC. The partial bandwidth is defined as a bandwidth part (BWP) for simplicity. Here, the BWP may be composed of resource blocks (RBs) contiguous on the frequency axis, and may correspond to one numerology (e.g., sub-carrier spacing, CP length, slot/mini-slot duration).

The BS may configure multiple BWPs in one CC configured for the UE. For example, a BWP occupying a relatively small frequency region may be configured in a PDCCH monitoring slot, and a PDSCH indicated by the PDCCH in a larger BWP may be scheduled. Alternatively, when UEs are concentrated in a specific BWP, some of the UEs may be configured in another BWP for load balancing. Alternatively, a spectrum in the middle of the entire bandwidth may be punctured and two BWPs on both sides may be configured in the same slot in consideration of frequency-domain inter-cell interference cancellation between neighbor cells. That is, the BS may configure at least one DL/UL BWP for the UE associated with the wideband CC and activate at least one DL/UL BWP among the configured DL/UL BWP(s) at a specific time (through L1 signaling, MAC CE or RRC signalling, etc.). The BS may instruct the UE to switch to another configured DL/UL BWP (through L1 signaling, MAC CE or RRC signalling, etc.). Alternatively, when a timer expires, the UE may switch to a predetermined DL/UL BWP. The activated DL/UL BWP is defined as an active DL/UL BWP. The UE may fail to receive DL/UL BWP configuration during an initial access procedure or before an RRC connection is set up. A DL/UL BWP assumed by the UE in this situation is defined as an initial active DL/UL BWP.

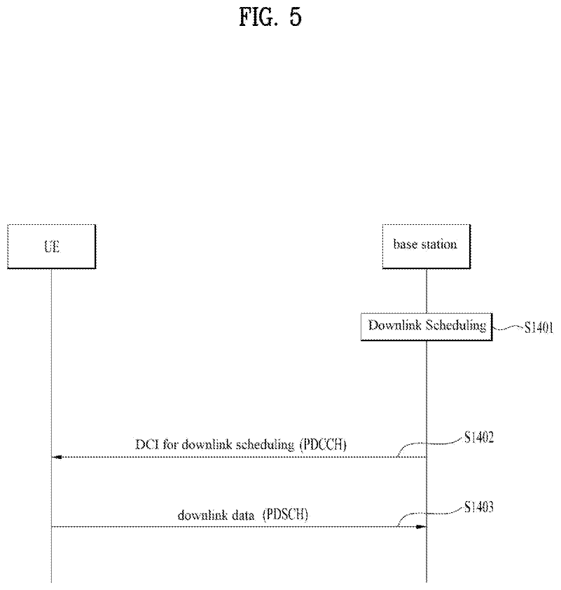

FIG. 5 illustrates a procedure in which a base station transmits a downlink (DL) signal to a UE

Referring to FIG. 5, the BS schedules DL transmission in relation to, for example, frequency/time resources, a transport layer, a DL precoder, and an MCS (S1401). In particular, the BS may determine a beam for PDSCH transmission to the UE through the above-described operations.

The UE receives downlink control information (DCI) for DL scheduling (i.e., including scheduling information about the PDSCH) from the BS on the PDCCH (S1402).

DCI format 1_0 or 1_1 may be used for DL scheduling. In particular, DCI format 1_1 includes the following information: an identifier for DCI formats, a bandwidth part indicator, frequency domain resource assignment, time domain resource assignment, a PRB bundling size indicator, a rate matching indicator, a ZP CSI-RS trigger, antenna port(s), transmission configuration indication (TCI), an SRS request, and a demodulation reference signal (DMRS) sequence initialization.

In particular, according to each state indicated in the antenna port(s) field, the number of DMRS ports may be scheduled, and single-user (SU)/multi-user (MU) transmission may also be scheduled.

In addition, the TCI field is configured in 3 bits, and the QCL for the DMRS is dynamically indicated by indicating a maximum of 8 TCI states according to the value of the TCI field.

The UE receives DL data from the BS on the PDSCH (S1403).

When the UE detects a PDCCH including DCI format 1_0 or 1_1, it decodes the PDSCH according to an indication by the DCI. Here, when the UE receives a PDSCH scheduled by DCI format 1, a DMRS configuration type may be configured for the UE by a higher layer parameter ‘dmrs-Type’, and the DMRS type is used to receive the PDSCH. In addition, the maximum number of front-loaded DMRS symbols for the PDSCH may be configured for the UE by the higher layer parameter ‘maxLength’.

In the case of DMRS configuration type 1, when a single codeword is scheduled for the UE and an antenna port mapped to an index of {2, 9, 10, 11, or 30} is specified, or when two codewords are scheduled for the UE, the UE assumes that any of the remaining orthogonal antenna ports is not associated with PDSCH transmission to another UE.

Alternatively, in the case of DMRS configuration type 2, when a single codeword is scheduled for the UE and an antenna port mapped to an index of {2, 10, or 23} is specified, or when two codewords are scheduled for the UE, the UE assumes that any of the remaining orthogonal antenna ports is not associated with PDSCH transmission to another UE.

When the UE receives the PDSCH, it may assume that the precoding granularity P′ is a consecutive resource block in the frequency domain. Here, P′ may correspond to one of {2, 4, wideband}.

When P′ is determined as wideband, the UE does not expect scheduling with non-contiguous PRBs, and may assume that the same precoding is applied to the allocated resources.

On the other hand, when P′ is determined as any one of {2, 4}, a precoding resource block group (PRG) is divided into P′ contiguous PRBs. The number of actually contiguous PRBs in each PRG may be greater than or equal to 1. The UE may assume that the same precoding is applied to contiguous DL PRBs in the PRG.

In order to determine a modulation order, a target code rate, and a transport block size in the PDSCH, the UE first reads the 5-bit MCD field in the DCI, and determines the modulation order and the target code rate. Then, it reads the redundancy version field in the DCI, and determines the redundancy version. Then, the UE determines the transport block size based on the number of layers and the total number of allocated PRBs before rate matching.

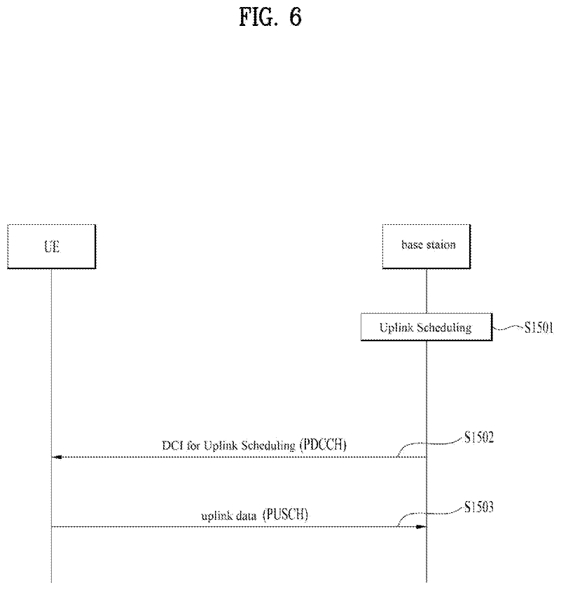

FIG. 6 illustrates a procedure in which a UE transmits an uplink (UL) signal to a BS.

Referring to FIG. 6, the BS schedules UL transmission in relation to, for example, frequency/time resources, a transport layer, a UL precoder, and an MCS (S1501). In particular, the BS may determine, through the above-described operations, a beam for PUSCH transmission of the UE.

The UE receives DCI for UL scheduling (including scheduling information about the PUSCH) from the BS on the PDCCH (S1502).

DCI format 0_0 or 0_1 may be used for UL scheduling. In particular, DCI format 0_1 includes the following information: an identifier for DCI formats, a UL/supplementary UL (SUL), a bandwidth part indicator, frequency domain resource assignment, time domain resource assignment, a frequency hopping flag, a modulation and coding scheme (MCS), an SRS resource indicator (SRI), precoding information and number of layers, antenna port(s), an SRS request, DMRS sequence initialization, and UL shared channel (UL-SCH) indicator.

In particular, SRS resources configured in an SRS resource set associated with the higher layer parameter ‘usage’ may be indicated by the SRS resource indicator field. In addition, ‘spatialRelationInfo’ may be configured for each SRS resource, and the value thereof may be one of {CRI, SSB, SRI}.

The UE transmits UL data to the BS on PUSCH (S1503).

When the UE detects a PDCCH including DCI format 0_0 or 0_1, it transmits the PUSCH according to an indication by the DCI.

For PUSCH transmission, two transmission schemes are supported: codebook-based transmission and non-codebook-based transmission:
i) When the higher layer parameter ‘txConfig’ is set to ‘codebook’, the UE is configured for codebook-based transmission. On the other hand, when the higher layer parameter ‘txConfig’ is set to ‘nonCodebook’, the UE is configured for non-codebook based transmission. When the higher layer parameter ‘txConfig’ is not configured, the UE does not expect scheduling by DCI format 0_1. When the PUSCH is scheduled according to DCI format 0_0, PUSCH transmission is based on a single antenna port.

In the case of codebook-based transmission, the PUSCH may be scheduled by DCI format 0_0 or DCI format 0_1, or scheduled semi-statically. When the PUSCH is scheduled by DCI format 0_1, the UE determines the PUSCH transmission precoder based on the SRI, transmit precoding matrix indicator (TPMI) and transmission rank from the DCI, as given by the SRS resource indicator field and the precoding information and number of layers field. The TPMI is used to indicate a precoder to be applied across antenna ports, and corresponds to an SRS resource selected by the SRI when multiple SRS resources are configured. Alternatively, when a single SRS resource is configured, the TPMI is used to indicate a precoder to be applied across antenna ports, and corresponds to the single SRS resource. A transmission precoder is selected from the UL codebook having the same number of antenna ports as the higher layer parameter ‘nrofSRS-Ports’. When the higher layer in which the UE is set to ‘codebook’ is configured with the parameter ‘txConfig’, at least one SRS resource is configured for the UE. The SRI indicated in slot n is associated with the most recent transmission of the SRS resource identified by the SRI, where the SRS resource precedes the PDCCH carrying the SRI (i.e., slot n).
ii) In the case of non-codebook-based transmission, the PUSCH may be scheduled by DCI format 0_0 or DCI format 0_1, or scheduled semi-statically. When multiple SRS resources are configured, the UE may determine the PUSCH precoder and transmission rank based on the wideband SRI. Here, the SRI is given by the SRS resource indicator in the DCI or by the higher layer parameter ‘srs-Resourcelndicator’. The UE may use one or multiple SRS resources for SRS transmission. Here, the number of SRS resources may be configured for simultaneous transmission within the same RB based on UE capability. Only one SRS port is configured for each SRS resource. Only one SRS resource may be configured by the higher layer parameter ‘usage’ set to ‘nonCodebook’. The maximum number of SRS resources that may be configured for non-codebook-based UL transmission is 4. The SRI indicated in slot n is associated with the most recent transmission of the SRS resource identified by the SRI, where the SRS transmission precedes the PDCCH carrying the SRI (i.e., slot n).

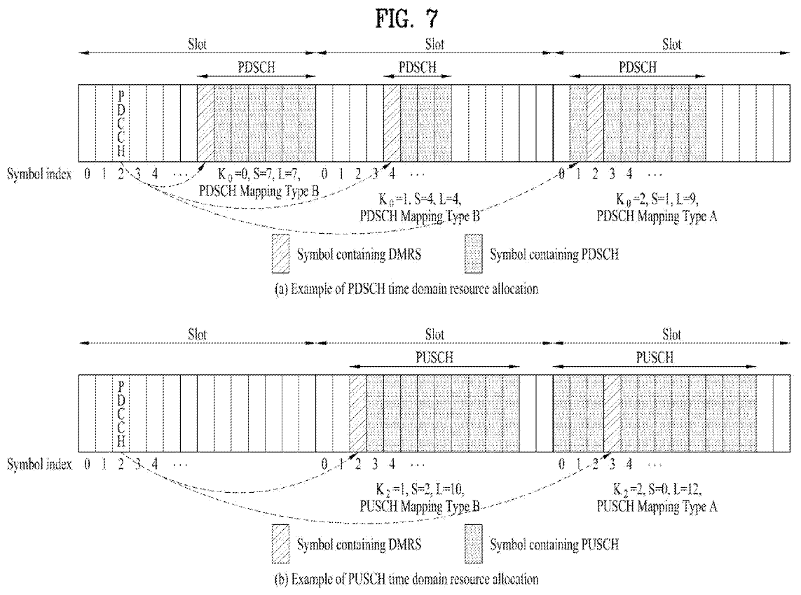

FIG. 7 illustrates an example of time domain resource allocation for a PDSCH by a PDCCH and an example of time domain resource allocation for a PUSCH by a PDCCH.

DCI carried by the PDCCH in order to schedule a PDSCH or a PUSCH includes a (time domain resource assignment, TDRA) field. The TDRA field provides a value m for a row index m+1 to an allocation table for the PDSCH or the PUSCH. Predefined default PDSCH time domain allocation is applied as the allocation table for the PDSCH, or a PDSCH TDRA table that the BS configures through RRC signaled pdsch-TimeDomainAllocationList is applied as the allocation table for the PDSCH. Predefined default PUSCH time domain allocation is applied as the allocation table for the PDSCH, or a PUSCH TDRA table that the BS configures through RRC signaled pusch-TimeDomainAllocationList is applied as the allocation table for the PUSCH. The PDSCH TDRA table to be applied and/or the PUSCH TDRA table to be applied may be determined according a fixed/predefined rule (e.g., refer to 3GPP TS 38.214)

In PDSCH time domain resource configurations, each indexed row defines a DL assignment-to-PDSCH slot offset K₀, a start and length indicator value SLIV (or directly, a start position (e.g., start symbol index S) and an allocation length (e.g., the number of symbols, L) of the PDSCH in a slot), and a PDSCH mapping type. In PUSCH time domain resource configurations, each indexed row defines a UL grant-to-PUSCH slot offset K₂, a start position (e.g., start symbol index S) and an allocation length (e.g., the number of symbols, L) of the PUSCH in a slot, and a PUSCH mapping type. K₀ for the PDSCH and K₂ for the PUSCH indicate the difference between the slot with the PDCCH and the slot with the PDSCH or PUSCH corresponding to the PDCCH. SLIV denotes a joint indicator of the start symbol S relative to the start of the slot with the PDSCH or PUSCH and the number of consecutive symbols, L, counting from the symbol S. The PDSCH/PUSCH mapping type includes two mapping types: one is mapping Type A and the other is mapping Type B. In PDSCH/PUSCH mapping Type A, a demodulation reference signal (DMRS) is located in the third symbol (symbol #2) or fourth symbol (symbol #3) in a slot according to RRC signaling. In PDSCH/PUSCH mapping Type B, the DMRS is located in the first symbol allocated for the PDSCH/PUSCH.

The scheduling DCI includes an FDRA field that provides assignment information about RBs used for the PDSCH or the PUSCH. For example, the FDRA field provides information about a cell for PDSCH or PUSCH transmission, information about a BWP for PDSCH or PUSCH transmission, and/or information about RBs for PDSCH or PUSCH transmission to the UE.

* Resource allocation by RRC

As mentioned above, there are two types of transmission without a dynamic grant: configured grant Type 1 and configured grant Type 2. In configured grant Type 1, a UL grant is provided by RRC signaling and stored as a configured UL grant. In configured grant Type 2, the UL grant is provided by the PDCCH and stored or cleared as the configured UL grant based on L1 signaling indicating configured UL grant activation or deactivation. Type 1 and Type 2 may be configured by RRC signaling per serving cell and per BWP. Multiple configurations may be simultaneously activated on different serving cells.

When configured grant Type 1 is configured, the UE may be provided with the following parameters through RRC signaling:
cs-RNTI corresponding to a CS-RNTI for retransmission;
periodicity corresponding to a periodicity of configured grant Type 1;
timeDomainOffset indicating an offset of a resource with respect to system frame number (SFN)=0 in the time domain;
timeDomainAllocation value m that provides a row index m+1 pointing to the allocation table, indicating a combination of the start symbol S, the length L, and the PUSCH mapping type;
frequencyDomainAllocation that provides frequency domain resource allocation; and
mcsAndTBS that provides IMCS indicating a modulation order, a target code rate, and a transport block size.

Upon configuration of configured grant Type 1 for a serving cell by RRC, the UE stores the UL grant provided by RRC as a configured UL grant for an indicated serving cell and initializes or re-initializes the configured UL grant to start in a symbol according to timeDomainOffset and S (derived from SLIV) and to recur with periodicity. After the UL grant is configured for configured grant Type 1, the UE may consider that the UL grant recurs in association with each symbol satisfying: [(SFN*numberOfSlotsPerFrame (numberOfSymbolsPerSlot)+(slot number in the frame*numberOfSymbolsPerSlot)+symbol number in the slot]=(timeDomainOffset*numberOfSymbolsPerSlot+S+N*periodicity) modulo (1024*numberOfSlotsPerFrame*numberOfSymbolsPerSlot), for all N>=0, where numberOfSlotsPerFrame and numberOfSymbolsPerSlot indicate the number of consecutive slots per frame and consecutive OFDM symbols per slot.

For configured grant Type 2, the UE may be provided with the following parameters by the BS through RRC signaling:
cs-RNTI corresponding to a CS-RNTI for activation, deactivation, and retransmission; and
periodicity that provides a periodicity of configured grant Type 2.

An actual UL grant is provided to the UE by the PDCCH (addressed to the CS-RNTI). After the UL grant is configured for configured grant Type 2, the UE may consider that the UL grant recurs in association with each symbol satisfying: [(SFN*numberOfSlotsPerFrame*numberOfSymbolsPerSlot)+(slot number in the frame*numberOfSymbolsPerSlot)+symbol number in the slot]=[(SFN_{start time}*numberOfSlotsPerFrame*numberOfSymbolsPerSlot+slot_{start time}*numberOfSymbolsPerSlot+symbol_{start time})+N*periodicity] modulo (1024*numberOfSlotsPerFrame*numberOfSymbolsPerSlot), for all N>=0, where SFN_{start time}, slot_{start time}, and symbol_{start time} represent an SFN, a slot, and a symbol, respectively, of the first transmission opportunity of the PUSCH after the configured grant is (re-)initialized, and numberOfSlotsPerFrame and numberOfSymbolsPerSlot indicate the number of consecutive slots per frame and consecutive OFDM symbols per slot, respectively.

On DL, the UE may be configured with SPS per serving cell and per BWP by RRC signaling from the BS. For DL SPS, DL assignment is provided to the UE by the PDCCH and stored or cleared based on L1 signaling indicating SPS activation or deactivation. When SPS is configured, the UE may be provided with the following parameters by the BS through RRC signaling:
cs-RNTI corresponding to a CS-RNTI for activation, deactivation, and retransmission;
nrofHARQ-Processes that provides the number of HARQ processes for SPS; and
periodicity that provides a periodicity of configured DL assignment for SPS.

After DL assignment is configured for SPS, the UE may consider sequentially that N-th DL assignment occurs in a slot satisfying: (numberOfSlotsPerFrame*SFN+slot number in the frame)=[(numberOfSlotsPerFrame*SFN_{start time}+slot_{start time})+N*periodicity*numberOfSlotsPerFrame/10] modulo (1024*numberOfSlotsPerFrame), where SFN_{start time} and slot_{start time} represent an SFN and a slot, respectively, of first transmission of the PDSCH after configured DL assignment is (re-)initialized, and numberOfSlotsPerFrame and numberOfSymbolsPerSlot indicate the number of consecutive slots per frame and consecutive OFDM symbols per slot, respectively.

If the CRC of a corresponding DCI format is scrambled with the CS-RNTI provided by the RRC parameter cs-RNTI, and a new data indicator field for an enabled transport block is set to 0, the UE validates, for scheduling activation or scheduling release, a DL SPS assignment PDCCH or a configured UL grant Type 2 PDCCH. Validation of the DCI format is achieved if all fields for the DCI format are set. An example of special fields for DL SPS and UL grant Type 2 scheduling activation PDCCH validation, and an example of special fields for DL SPS and UL grant Type 2 scheduling release PDCCH validation.

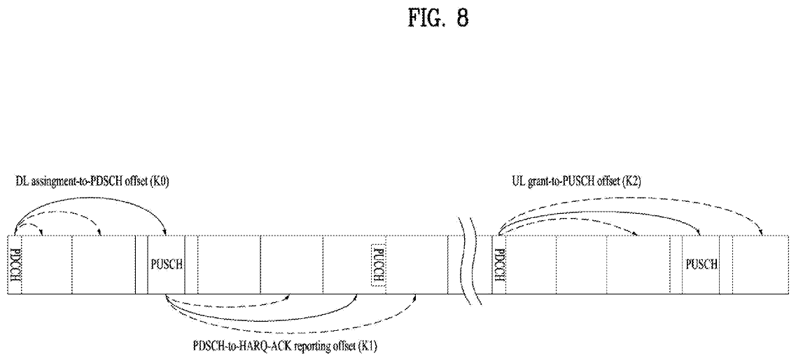

FIG. 8 is a diagram for explaining hybrid automatic repeat request acknowledgement (HARQ-ACK) operation for a user equipment (UE) to report control information.

In NR, HARQ may have the following characteristics (hereinafter referred to as H-1 and H-2).
H-1) One bit of HARQ-ACK feedback may be supported for each transport block (TB). Some UEs may support one DL HARQ process, but a given UE may support one or more DL HARQ processes.
H-2) The UE may support a set of minimum HARQ processing times. The minimum HARQ processing time refers to the minimum time required for the UE to transmit a HARQ-ACK in response to DL data received from the BS. To this end, two types of UE processing times (N1 and K1) may be defined according to (1) symbol granularity and (2) slot granularity. Here, K1 denotes the number of slots from a PDSCH slot to a slot for transmitting a HARQ in response to the PDSCH.

From the perspective of the UE, N1 denotes the number of OFDM symbols required for UE processing from the end of PDSCH reception to the earliest starting point available for HARQ-ACK transmission. N1 may be defined as shown in Tables 5 and 6 below depending on OFDM numerologies (i.e., subcarrier spacings) and DMRS patterns.

TABLE 5

| | HARQ Timing | | 15 kHz | 30 kHz | 60 kHz | 120 kHz |
|---|---|---|---|---|---|---|
| configuration | Parameter | Units | SCS | SCS | SCS | SCS |
| Front-loaded DMRS only | N1 | Symbols | 8 | 10 | 17 | 20 |
| Front-loaded DMRS only + | N1 | Symbols | 13 | 13 | 20 | 124 |
| additional DMRS | | | | | | |

TABLE 6

| | HARQ Timing | | 15 kHz | 30 kHz | 60 kHz |
|---|---|---|---|---|---|
| configuration | Parameter | Units | SCS | SCS | SCS |
| Front-loaded DMRS only | N1 | Symbols | 3 | 14.5 | 9(FR1) |
| Front-loaded DMRS | N1 | Symbols | [13] | [13] | [20] |
| only + additional | | | | | |
| DMRS | | | | | |

Referring to FIG. 8, the HARQ-ACK timing (K1) may indicate the number of slots from a PDSCH slot to a slot for transmitting a HARQ-ACK in response to the PDSCH. K0 denotes the number of slots from a slot with a DL grant PDCCH to a slot with corresponding PDSCH transmission, and K2 denotes the number of slots from a slot with a UL grant PDCCH to a slot with corresponding PUSCH transmission. Specifically, KO, K1, and K2 may be briefly summarized as shown in Table 7 below.

TABLE 7

| | A | B |
|---|---|---|
| K0 | DL scheduling DCI | Corresponding DL data transmission |
| K1 | DL data reception | Corresponding HARQ-ACK |
| K2 | UL scheduling DCI | Corresponding UL data transmission |

A slot timing between A and B may be indicated by a specific field of DCI from a set of values. In addition, NR supports different minimum HARQ processing times for UEs. The HARQ processing time may include a delay between the reception timing of DL data and the transmission timing of a HARQ-ACK for the DL data and a delay between the reception timing of a UL grant and the transmission timing of UL data related to the UL grant. The UE may provide its capability regarding the minimum HARQ processing time to the BS. Asynchronous and adaptive DL HARQ may be supported at least for enhanced Mobile Broadband (eMBB) and Ultra Reliable Low Latency Communications (URLLC).

From the perspective of the UE, HARQ ACK/NACK feedback for multiple DL transmissions may be transmitted in one UL data/control region in the time domain. The timing between DL data reception and an ACK in response to DL data may be indicated by a field of DCI from a set of values, which is configured by higher layers. The timing may be defined at least for a case where the timing is unknown to the UE.

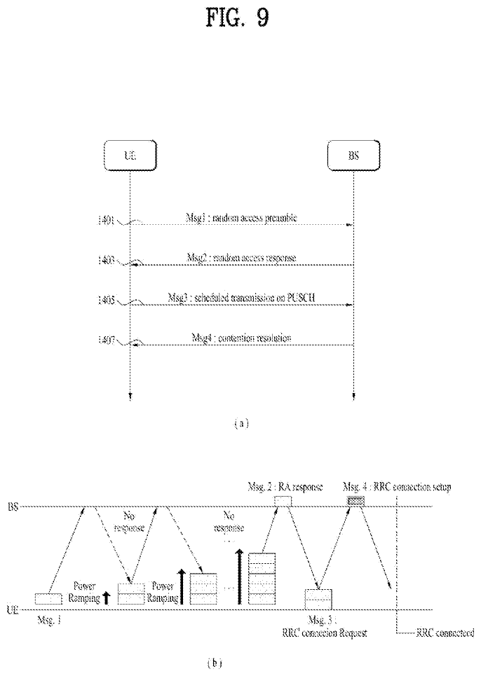

FIG. 9 is a diagram illustrating an example of a random access procedure to which various embodiments are applicable.

Referring to FIG. 9, When a (contention-based) RACH procedure is performed in four steps (4-step RACH procedure), the UE may transmit a message (Message 1 (Msg 1)) including a preamble related to a specific sequence on a PRACH (1401) and receive a PDCCH and an RAR message (Message 2 (Msg 2)) on a PDSCH corresponding to the PDCCH in response to the preamble (1403). The UE may transmit a message (Message 3 (Msg 3)) including a PUSCH by using scheduling information included in the RAR (1405) and perform a contention resolution procedure such as reception of a PDCCH signal and a PDSCH signal corresponding to the PDCCH signal. The UE may receive a message (Message 4 (Msg 4)) including contention resolution information for the contention resolution procedure from the BS (1407).

The 4-step RACH procedure of the UE may be summarized in Table 8 below.

TABLE 8

| | Type of Signals | Operations/Information obtained |
|---|---|---|
| 1^{st} step | PRACH preamble | Initial beam acquisition |
| | in UL | Random election of RA-preamble ID |
| 2^{nd} Step | Random Access | Timing alignment information |
| | Response on | RA-preamble ID |
| | DL-SCH | Initial UL grant, Temporary C-RNTI |
| 3^{rd} Step | UL transmission | RRC connection request |
| | on UL-SCH | UE identifier |
| 4^{th} Step | Contention | Temporary C-RNTI on PDCCH for initial |
| | Resolution | access |
| | on DL | C-RNTI on PDCCH for UE in |
| | | RRC_CONNECTED |

First, the UE may transmit an RACH preamble as Msg 1 on a PRACH in an RACH procedure.

Random access preamble sequences of two different lengths are supported. The length 839 of the longer sequence is applied to the SCSs of 1.25 kHz and 5 kHz, whereas the length 139 of the shorter sequence is applied to the SCSs of 15 kHz, 30 kHz, 60 kHz, and 120 kHz.

Multiple preamble formats are defined by one or more RACH OFDM symbols and different CPs (and/or guard times). An RACH configuration for a cell is provided in system information of the cell to the UE. The RACH configuration includes information about a PRACH SCS, available preambles, and a preamble format. The RACH configuration includes information about associations between SSBs and RACH (time-frequency) resources. The UE transmits an RACH preamble in RACH time-frequency resources associated with a detected or selected SSB.

An SSB threshold for RACH resource association may be configured by the network, and an RACH preamble is transmitted or retransmitted based on an SSB having a reference signal received power (RSRP) measurement satisfying the threshold. For example, the UE may select one of SSBs satisfying the threshold, and transmit or retransmit an RACH preamble in RACH resources associated with the selected SSB.

Upon receipt of the RACH preamble from the UE, the BS transmits an RAR message (Msg 2) to the UE. A PDCCH that schedules a PDSCH carrying the RAR is cyclic redundancy check (CRC)-masked by a random access radio network temporary identifier (RA-RNTI) and transmitted. Upon detection of the PDCCH masked by the RA-RNTI, the UE may receive an RAR on a PDSCH scheduled by DCI carried on the PDCCH. The UE determines whether the RAR includes RAR information for its transmitted preamble, that is, Msg 1. The UE may make the determination by checking the presence or absence of the RACH preamble ID of its transmitted preamble in the RAR. In the absence of the response to Msg 1, the UE may retransmit the RACH preamble a predetermined number of or fewer times, while performing power ramping. The UE calculates PRACH transmission power for a preamble retransmission based on the latest path loss and a power ramping counter.

The RAR information may include the preamble sequence transmitted by the UE, a cell RNTI (C-RNTI) that the BS has allocated to the UE attempting random access, UL transmit time alignment information, UL transmission power adjustment information, and UL radio resource allocation information. Upon receipt of its RAR information on the PDSCH, the UE may acquire time advance information for UL synchronization, an initial UL grant, and a temporary C-RNTI. The timing advance information is used to control a UL signal transmission timing. To align a PUSCH and/or PUCCH transmission of the UE with a subframe timing of a network end, the network (e.g., the BS) may measure the time difference between PUSCH, PUCCH, or SRS reception and a subframe and transmit the timing advance information based on the time difference. The UE may transmit a UL signal as Msg 3 of the RACH procedure on a UL-SCH based on the RAR information. Msg 3 may include an RRC connection request and a UE ID. The network may transmit Msg 4 in response to Msg 3. Msg 4 may be handled as a contention resolution message on DL. As the UE receives Msg 4, the UE may enter the RRC_CONNECTED state.

As described before, the UL grant included in the RAR schedules a PUSCH transmission for the UE. A PUSCH carrying an initial UL transmission based on the UL grant of the RAR is referred to as an Msg 3 PUSCH.

A (contention-based) RACH procedure performed in two steps, that is, a 2-step RACH procedure has been proposed to simplify the RACH procedure and thus achieve low signaling overhead and low latency

In the 2-step RACH procedure, the operation of transmitting Msg 1 and the operation of transmitting Msg 3 in the 4-step RACH procedure may be incorporated into an operation of transmitting one message, Message A (Msg A) including a PRACH and a PUSCH by the UE. The operation of transmitting Msg 2 by the BS and the operation of transmitting Msg 4 by the BS in the 4-step RACH procedure may be incorporated into an operation of transmitting one message, Message B (Msg B) including an RAR and contention resolution information.

That is, in the 2-step RACH procedure, the UE may combine Msg 1 and Msg 3 of the 4-step RACH procedure into one message (e.g., Msg A) and transmit the message to the BS.

Further, in the 2-step RACH procedure, the BS may combine Msg 2 and Msg 4 of the 4-step RACH procedure into one message (e.g., Msg B) and transmit the message to the UE.

The 2-step RACH procedure may become a low-latency RACH procedure based on the combinations of these messages.

More specifically, Msg A may include a PRACH preamble included in Msg 1 and data included in Msg 3 in the 2-step RACH procedure. In the 2-step RACH procedure, Msg B may include an RAR included in Msg 2 and contention resolution information included in Msg 4.

Also, the contention-free RACH procedure may be used for handover of the UE to another cell or BS or may be performed when requested by a BS command. The contention-free RACH procedure is basically similar to the contention-based RACH procedure. However, compared to the contention-based RACH procedure in which a preamble to be used is randomly selected from among a plurality of RACH preambles, a preamble to be used by the UE (referred to as a dedicated RACH preamble) is assigned to the UE by the BS in the contention-free RACH procedure. Information about the dedicated RACH preamble may be included in an RRC message (e.g., a handover command) or provided to the UE by a PDCCH order. When the RACH procedure starts, the UE transmits the dedicated RACH preamble to the BS. When the UE receives an RAR from the BS, the RACH procedure is completed.

In the contention-free RACH procedure, a CSI request field in an RAR UL grant indicates whether the UE is to include an aperiodic CSI report in a corresponding PUSCH transmission. An SCS for Msg 3 PUSCH transmission is provided by an RRC parameter. The UE may transmit the PRACH and the Msg 3 PUSCH on the same UL carrier of the same serving cell. A UL BWP for the Msg 3 PUSCH transmission is indicated by SIB1.

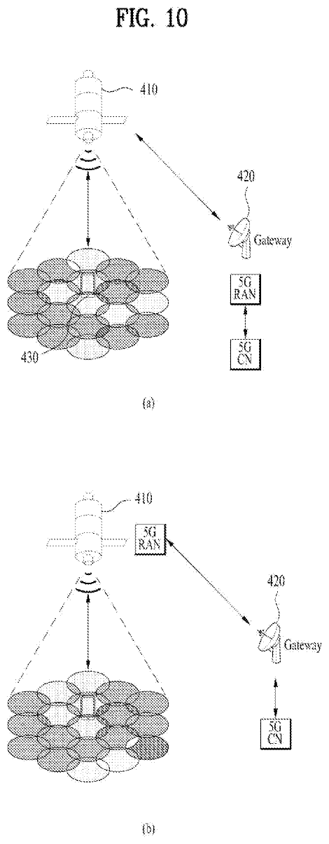

FIG. 10 illustrates a non-terrestrial network (NTN).

A non-terrestrial network (NTN) refers to a wireless network configured using satellites (e.g., geostationary earth orbit satellites (GEO)/low-earth orbit satellites (LEO)). Based on the NTN, coverage may be extended and a highly reliable network service may be provided. For example, the NTN may be configured alone, or may be combined with a conventional terrestrial network to configure a wireless communication system. For example, in the NTN network, i) a link between a satellite and a UE, ii) a link between satellites, iii) a link between a satellite and a gateway, and the like may be configured.

The following terms may be used to describe the configuration of a wireless communication system employing satellites.
Satellite: a space-borne vehicle embarking a bent pipe payload or a regenerative payload telecommunication transmitter, placed into Low-Earth Orbit (LEO) typically at an altitude between 500 km to 2000 km, Medium-Earth Orbit (MEO) typically at an altitude between 8000 to 20000 lm, or Geostationary satellite Earth Orbit (GEO) at 35 786 km altitude.
Satellite network: Network, or segments of network, using a space-borne vehicle to embark a transmission equipment relay node or base station.
Satellite RAT: a RAT defined to support at least one satellite.
5G Satellite RAT: a Satellite RAT defined as part of the New Radio.
5G satellite access network: 5G access network using at least one satellite.
Terrestrial: located at the surface of Earth.
Terrestrial network: Network, or segments of a network located at the surface of the Earth.

Use cases that may be provided by a communication system employing a satellite connection may be divided into three categories. The “Service Continuity” category may be used to provide network connectivity in geographic areas where 5G services cannot be accessed through the wireless coverage of terrestrial networks. For example, a satellite connection may be used for a UE associated with a pedestrian user or a UE on a moving land-based platform (e.g., car, coach, truck, train), air platform (e.g., commercial or private jet) or marine platform (e.g., marine vessel). In the “Service Ubiquity” category, when terrestrial networks are unavailable (due to, for example, disaster, destruction, economic situations, etc.), satellite connections may be used for IOT/public safety-related emergency networks/home access, etc. The “Service Scalability” category includes services using wide coverage of satellite networks.

For example, a 5G satellite access network may be connected to a 5G core Network. In this case, the satellite may be a bent pipe satellite or a regenerative satellite. The NR radio protocols may be used between the UE and the satellite. Also, F1 interface may be used between the satellite and the gNB.

As described above, a non-terrestrial network (NTN) refers to a wireless network configured using a device that is not fixed on the ground, such as satellite. A representative example is a satellite network. Based on the NTN, coverage may be extended and a highly reliable network service may be provided. For example, the NTN may be configured alone, or may be combined with an existing terrestrial network to configure a wireless communication system.

Use cases that may be provided by a communication system employing an NTN may be divided into three categories. The “Service Continuity” category may be used to provide network connectivity in geographic areas where 5G services cannot be accessed through the wireless coverage of terrestrial networks. For example, a satellite connection may be used for a UE associated with a pedestrian user or a UE on a moving land-based platform (e.g., car, coach, truck, train), air platform (e.g., commercial or private jet) or marine platform (e.g., marine vessel). In the “Service Ubiquity” category, when terrestrial networks are unavailable (due to, for example, disaster, destruction, economic situations, etc.), satellite connections may be used for IOT/public safety-related emergency networks/home access, etc. The “Service Scalability” category includes services using wide coverage of satellite networks.

Referring to FIG. 10, the NTN includes one or more satellites 410, one or more NTN gateways 420 capable of communicating with the satellites, and one or more UEs (/BSs) 430 capable of receiving mobile satellite services from the satellites. For simplicity, the description is focused on the example of the NTN including satellites, but is not intended to limit the scope of the present disclosure. Accordingly, the NTN may include not only the satellites, but also aerial vehicles (Unmanned Aircraft Systems (UAS) encompassing tethered UAS (TUA), Lighter than Air UAS (LTA), Heavier than Air UAS (HTA), all operating in altitudes typically between 8 and 50 km including High Altitude Platforms (HAPs)).

The satellite 410 is a space-borne vehicle equipped with a bent pipe payload or a regenerative payload telecommunication transmitter and may be located in a low earth orbit (LEO), a medium earth orbit (MEO), or a geostationary earth orbit (GEO). The NTN gateway 420 is an earth station or gateway existing on the surface of the earth, and provides sufficient RF power/sensitivity to access the satellite. The NTN gateway corresponds to a transport network layer (TNL) node.

The NTN may have i) a link between a satellite and a UE, ii) a link between satellites, iii) a link between a satellite and an NTN gateway. A service link refers to a radio link between a satellite and a UE. Inter-satellite links (ISLs) between satellites may be present when there are multiple satellites. A feeder link refers to a radio link between an NTN gateway and a satellite (or UAS platform). The gateway may be connected to a data network and may communicate with a satellite through the feeder link. The UE may communicate via the satellite and service link.

As NTN operation scenarios, two scenarios which are based on transparent payload and regenerative payload, respectively may be considered. FIG. 9-(a) shows an example of a scenario based on a transparent payload. In the scenario based on the transparent payload, the signal repeated by the payload is not changed. The satellites 410 repeat the NR-Uu radio interface from the feeder link to the service link (or vice versa), and the satellite radio interface (SRI) on the feeder link is NR-Uu. The NTN gateway 420 supports all functions necessary to transfer the signal of the NR-Uu interface. Also, different transparent satellites may be connected to the same gNB on the ground. FIG. 9-(b) shows an example of a scenario based on a regenerative payload. In the scenario based on the regenerative payload, the satellite 410 may perform some or all of the functions of a conventional BS (e.g., gNB), and may thus perform some or all of frequency conversion/demodulation/decoding/modulation. The service link between the UE and a satellite is established using the NR-Uu radio interface, and the feeder link between the NTN gateway and a satellite is established using the satellite radio interface (SRI). The SRI corresponds to a transport link between the NTN gateway and the satellite.

The UE 430 may be connected to 5GCN through an NTN-based NG-RAN and a conventional cellular NG-RAN simultaneously. Alternatively, the UE may be connected to the 5GCN via two or more NTNs (e.g., LEO NTN and GEO NTN, etc.) simultaneously.

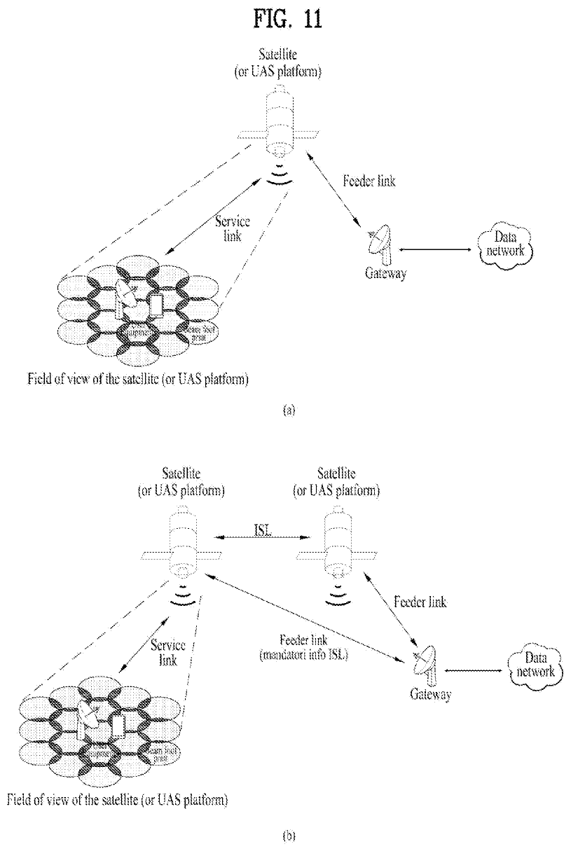

FIG. 11 illustrates an overview and a scenario of an NTN.

NTN refers to a network or network segment in which a satellite (or UAS platform) uses RF resources. Typical scenarios of the NTN providing access to a UE include an NTN scenario based on a transparent payload as shown in FIG. 11-(a) and an NTN scenario based on a regenerative payload as shown in FIG. 11-(b).

NTN typically features the following elements,
One or several sat-gateways that connect the Non-Terrestrial Network to a public data network
A GEO satellite is fed by one or several sat-gateways which are deployed across the satellite targeted coverage (e.g. regional or even continental coverage). We assume that UE in a cell are served by only one sat-gateway.

A Non-GEO satellite served successively by one or several sat-gateways at a time. The system ensures service and feeder link continuity between the successive serving sat-gateways with sufficient time duration to proceed with mobility anchoring and hand-over.
A feeder link or radio link between a sat-gateway and the satellite (or UAS platform)
A service link or radio link between the user equipment and the satellite (or UAS platform).
A satellite (or UAS platform) which may implement either a transparent or a regenerative (with on board processing) payload. The satellite (or UAS platform) generate beams typically generate several beams over a given service area bounded by its field of view. The footprints of the beams are typically of elliptic shape. The field of view of a satellites (or UAS platforms) depends on the on board antenna diagram and min elevation angle.
A transparent payload: Radio Frequency filtering, Frequency conversion and amplification. Hence, the waveform signal repeated by the payload is un-changed;
A regenerative payload: Radio Frequency filtering, Frequency conversion and amplification as well as demodulation/decoding, switch and/or routing, coding/modulation. This is effectively equivalent to having all or part of base station functions (e.g. gNB) on board the satellite (or UAS platform).
Inter-satellite links (ISL) optionally in case of a constellation of satellites. This will require regenerative payloads on board the satellites. ISL may operate in RF frequency or optical bands.
User Equipment is served by the satellite (or UAS platform) within the targeted service area.

Table 9 below defines various types of satellites (or UAS platforms).

TABLE 9

| | | | | Typical beam | |
|---|---|---|---|---|---|
| Platforms | Altitude range | | Orbit | footprint size | |
| Low-Earth Orbit | 300-1500 | km | Circular around the earth | 100-1000 | km |
| (LEO) satellite | | | | | |
| Medium-Earth | 7000-25000 | km | | 100-1000 | km |
| Orbit (MEO) | | | | | |
| satellite | | | | | |
| Geostationary Earth | 35 786 | km | notional station keeping | 200-3500 | km |
| Orbit (GEO) | | | position fixed in terms of | | |
| satellite | | | elevation/azimuth with | | |
| UAS platform | 8-50 km | | respect to a given earth point | 5-200 | km |
| (including HAPS) | (20 km for HAPS) | | | | |
| High Elliptical | 400-50000 | km | Elliptical around the earth | 200-3500 | km |

Orbit (HEO)
satellite

Typically, GEO satellite and UAS are used to provide continental, regional or local service. A constellation of LEO and MEO is used to provide services in both Northern and Southern hemispheres. In some case, the constellation can even provide global coverage including polar regions. For the later, this requires appropriate orbit inclination, sufficient beams generated and inter-satellite links. HEO satellite systems are not considered in this document.

An NTN that provides access to a terminal in six reference scenarios described below can be considered.

Circular orbiting and notional station keeping platforms.

Highest RTD constraint

Highest Doppler constraint

A transparent and a regenerative payload

One ISL case and one without ISL. Regenerative payload is mandatory in the case of inter-satellite links.

Fixed or steerable beams resulting respectively in moving or fixed beam foot print on the ground

Six scenarios are considered as depicted in Table 10 and are detailed in Table 11.

TABLE 10

| | Transparent | Regenerative |
|---|---|---|
| | satellite | satellite |
| GEO based non-terrestrial access network | Scenario A | Scenario B |
| LEO based non-terrestrial access network: | Scenario C1 | Scenario D1 |
| steerable beams | | |
| LEO based non-terrestrial access network: | Scenario C2 | Scenario D2 |
| the beams move with the satellite | | |

TABLE 11

| | GEO based non-terrestrial access | LEO based non-terrestrial access |
|---|---|---|
| Scenarios | network (Scenario A and B) | network (Scenario C & D) |
| Orbit type | notional station keeping position | circular orbiting around the earth |
| | fixed in terms of | |
| | elevation/azimuth with respect to | |
| | a given earth point | |
| Altitude | 35,786 km | 600 km |
| | | 1,200 km |
| Spectrum (service link) | <6 GHZ (e.g. 2 GHz) | |
| | >6 GHz (e.g. DL 20 GHz, UL 30 GHz) | |
| Max channel bandwidth | 30 MHz for band <6 GHz | |
| capability (service link) | 1 GHz for band >6 GHz | |
| Payload | Scenario A: Transparent | Scenario C: Transparent |
| | (including radio frequency | (including radio frequency |
| | function only) | function only) |
| | Scenario B: regenerative | Scenario D: Regenerative |
| | (including all or part of RAN | (including all or part of RAN |
| | functions) | functions) |
| Inter-Satellite link | No | Scenario C: No |
| | | Scenario D: Yes/No (Both |
| | | cases are possible.) |
| Earth-fixed beams | Yes | Scenario C1: Yes (steerable |
| | | beams), see note 1 |
| | | Scenario C2: No (the beams |
| | | move with the satellite) |
| | | Scenario D 1: Yes (steerable |
| | | beams), see note 1 |
| | | Scenario D 2: No (the beams |
| | | move with the satellite) |
| Max beam foot print | 3500 km (Note 5) | 1000 km |
| size (edge to edge) | | |
| regardless of the | | |
| elevation angle | | |
| Min Elevation angle for | 10° for service link and 10° | 10° for service link and 10° |
| both sat-gateway and | for feeder link | for feeder link |
| user equipment | | |
| Max distance between | 40,581 km | 1,932 km (600 km altitude) |
| satellite and user | | 3,131 km (1,200 km altitude) |
| equipment at min | | |
| elevation angle | | |
| Max Round Trip Delay | Scenario A: 541.46 ms (service | Scenario C: (transparent |
| (propagation delay | and feeder links) | payload: service and feeder |
| only) | Scenario B: 270.73 ms (service | links) |
| | link only) | 25.77 ms (600 km) |
| | | 41.77 ms (1200 km) |
| | | Scenario D: (regenerative |
| | | payload: service link only) |
| | | 12.89 ms (600 km) |
| | | 20.89 ms (1200 km) |
| Max differential delay | 10.3 ms | 3.12 ms and 3.18 ms for |
| within a cell (Note 6) | | respectively 600 km |
| | | and 1200 km |
| Max Doppler shift | 0.93 ppm | 24 ppm (600 km) |
| (earth fixed user | | 21 ppm (1200 km) |
| equipment) | | |
| Max Doppler shift | 0.000 045 ppm/s | 0.27 ppm/s (600 km) |
| variation (earth fixed | | 0.13 ppm/s(1200 km) |
| user equipment) | | |
| User equipment motion | 1200 km/h (e.g. aircraft) | 500 km/h (e.g. high speed |
| on the earth | | train) |
| | | Possibly 1200 km/h (e.g. |
| | | aircraft) |
| User equipment antenna | Omnidirectional antenna (linear polarisation), assuming 0 dBi | |
| types | Directive antenna (up to 60 cm equivalent aperture diameter in | |
| | circular polarisation) | |
| User equipment Tx | Omnidirectional antenna: UE power class 3 with up to 200 mW | |
| power | Directive antenna: up to 20 W | |
| User equipment Noise | Omnidirectional antenna: 7 dB | |
| figure | Directive antenna: 1.2 dB | |
| Service link | 3GPP defined New Radio | |
| Feeder link | 3GPP or non-3GPP defined | 3GPP or non-3GPP defined |
| | Radio interface | Radio interface |

NOTE 1:
Each satellite has the capability to steer beams towards fixed points on earth using beamforming techniques. This is applicable for a period of time corresponding to the visibility time of the satellite
NOTE 2:
Max delay variation within a beam (earth fixed user equipment) is calculated based on Min Elevation angle for both gateway and user equipment
NOTE 3:
Max differential delay within a beam is calculated based on Max beam foot print diameter at nadir
NOTE 4:
Speed of light used for delay calculation is 299792458 m/s.
NOTE 5:
The Maximum beam foot print size for GEO is based on current state of the art GEO High Throughput systems, assuming either spot beams at the edge of coverage (low elevation).
NOTE 6:
The maximum differential delay at cell level has been computed considering the one at beam level for largest beam size. It doesn't preclude that cell may include more than one beam when beam size ae small or medium size. However the cumulated differential delay of all beams within a cell will not exceed the maximum differential delay at cell level in the table above.

The NTN study results apply to GEO scenarios as well as all NGSO scenarios with circular orbit at altitude greater than or equal to 600 km.

Hereinafter, the NTN reference point will be described.

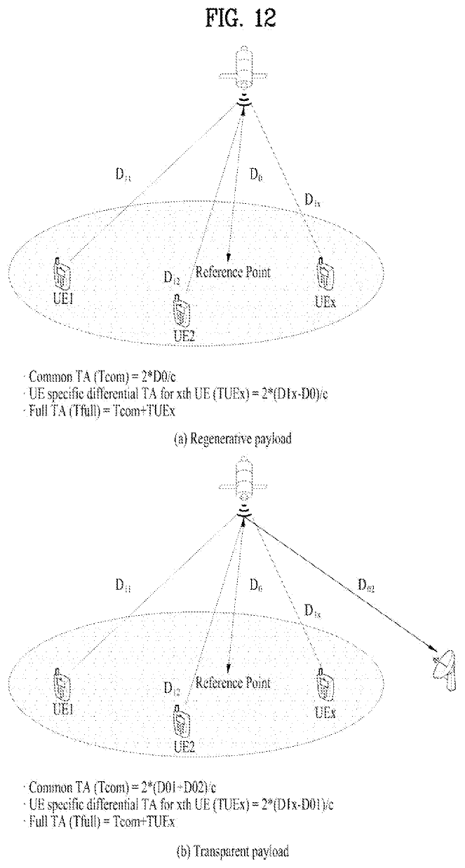

FIG. 12 illustrates TA components of the NTN. Here, the TA offset (NTAoffset) may not be plotted.

With consideration on the larger cell coverage, long round trip time (RTT) and high Doppler, enhancements are considered to ensure the performance for timing and frequency synchronization for UL transmission.

Referring to FIG. 12, a reference point related to timing advance (TA) of initial access and subsequent TA maintenance/management is illustrated. Terms defined in relation to FIG. 12 are described below.
Option 1: Autonomous acquisition of the TA at UE with UE known location and satellite ephemeris.

Regarding option 1, the required TA value for UL transmission including PRACH can be calculated by the UE. The corresponding adjustment can be done, either with UE-specific differential TA or full TA (consisting of UE specific differential TA and common TA).

W.r.t the full TA compensation at the UE side, both the alignment on the UL timing among UEs and DL and UL frame timing at network side can be achieved. However, in case of satellite with transparent payload, further discussion on how to handle the impact introduced by feeder link will be conducted in normative work. Additional needs for the network to manage the timing offset between the DL and UL frame timing can be considered, if impacts introduced by feeder link is not compensated by UE in corresponding compensation.

W.r.t the UE specific differential TA only, additional indication on a single reference point should be signalled to UEs per beam/cell for achieving the UL timing alignment among UEs within the coverage of the same beam/cell. Timing offset between DL and UL frame timing at the network side should also be managed by the network regardless of the satellite payload type.

With concern on the accuracy on the self-calculated TA value at the UE side, additional TA signalling from network to UE for TA refinement, e.g., during initial access and/or TA maintenance, can be determined in the normative work.
Option 2: Timing advanced adjustment based on network indication

Regarding option 2, the common TA, which refers to the common component of propagation delay shared by all UEs within the coverage of same satellite beam/cell, is broadcasted by the network per satellite beam/cell. The calculation of this common TA is conducted by the network with assumption on at least a single reference point per satellite beam/cell.

The indication for UE-specific differential TA from network as the Rel-15 TA mechanism is also needed. For satisfying the larger coverage of NTN, extension of value range for TA indication in RAR, either explicitly or implicitly, is identified. Whether to support negative TA value in corresponding indication will be determined in the normative phase. Moreover, indication of timing drift rate, from the network to UE, is also supported to enable the TA adjustment at UE side.

For calculation of common TA in the above two options, single reference point per beam is considered as the baseline. Whether and how to support the multiple reference points can be further discussed in the normative work.

For the UL frequency compensation, at least for LEO system, the following solutions are identified with consideration on the beam specific post-compensation of common frequency offset at the network side:
Regarding option 1, both the estimation and pre-compensation of UE-specific frequency offset are conducted at the UE side. The acquisition of this value can be done by utilizing DL reference signals, UE location and satellite ephemeris.
Regarding option 2, the required frequency offset for UL frequency compensation at least in LEO systems is indicated by the network to UE. The acquisition on this value can be done at the network side with detection of UL signals, e.g., preamble.

Indication of compensated frequency offset values by the network is also supported in case that compensation of the frequency offset is conducted by the network in the uplink and/or the downlink, respectively. However, indication of Doppler drift rate is not necessary.

Hereinafter, more delay-tolerant re-transmission mechanisms will be described in detail.

As follows, two main aspects of a retransmission mechanism with improved delay tolerance can be discussed.
Disabling of HARQ in NR NTN
HARQ optimization in NR-NTN

HARQ Round Trip Time in NR is of the order of several ms. The propagation delays in NTN are much longer, ranging from several milliseconds to hundreds of milliseconds depending on the satellite orbit. The HARQ RTT can be much longer in NTN. It was identified early in the study phase that there would be a need to discuss potential impact and solutions on HARQ procedure. RAN1 has focused on physical layer aspects while RAN2 has focused on MAC layer aspects.

In this regard, disabling of HARQ in NR NTN may be considered.

It was discussed that when UL HARQ feedback is disabled, there could be issues if (i) MAC CE and RRC signalling are not received by UE, or (ii) DL packets not correctly received by UE for a long period of time without gNB knowing it.

The following were discussed without convergence on the necessity of introducing such solutions for NTN when HARQ feedback is disabled
(1) Indicate HARQ disabling via DCI in new/re-interpreted field
(2) New UCI feedback for reporting DL transmission disruption and or requesting DL scheduling changes

The following possible enhancements for slot-aggregation or blind repetitions were considered. There is no convergence on the necessity of introducing such enhancements for NTN.
(1) Greater than 8 slot-aggregation
(2) Time-interleaved slot aggregation
(3) New MCS table

Next, a method for optimizing HARQ for the NR NTN will be described.

Solutions to avoid reduction in peak data rates in NTN were discussed. One solution is to increase the number of HARQ processes to match the longer satellite round trip delay to avoid stop-and-wait in HARQ procedure. Another solution is to disable UL HARQ feedback to avoid stop-and-wait in HARQ procedure and rely on RLC ARQ for reliability. The throughput performance for both types of solutions was evaluated at link level and system level by several contributing companies.

The observations from the evaluations performed on the effect of the number of HARQ processes on performance are summarized as follows:
Three sources provided link-level simulations of throughput versus SNR with the following observations:
One source simulated with a TDL-D suburban channel with elevation angle of 30 degrees with BLER target of 1% for RLC ARQ with 16 HARQ processes, and BLER targets 1% and 10% with 32/64/128/256 HARQ processes. There was no observable gain in throughput with increased number of HARQ processes compared to RLC layer re-transmission with RTT in {32, 64, 128, 256} ms.
One source simulated with a TDL-D suburban channel with elevation angle of 30 degrees with BLER targets of 0.1% for RLC ARQ with 16 HARQ processes, and BLER targets 1% and 10% with 32 HARQ processes. An average throughput gain of 10% was observed with 32 HARQ processes compared to RLC ARQ with 16 HARQ processes with RTT=32 ms.
One source provides the simulation results in following cases with RTT=32 ms, e.g., assuming BLER targets at 1% for RLC ARQ with 16 HARQ processes, BLER targets 1% and 10% with 32 HARQ processes. There is no observable gain in throughput with 32 HARQ processes compared to RLC ARQ with 16 HARQ processes in case that channel is assumed as TDL-D with delay spread/K-factor taken from system channel model in suburban scenario with elevation angle 30. Performance gain can be observed with other channels, especially, up to 12.5% spectral efficiency gain is achieved in case that channel is assumed as TDL-A in suburban with 300 elevation angle. Moreover, simulation based on the simulation with consideration on other scheduling operations: (i) additional MCS offset, (ii) MCS table based on lower efficiency (iii) slot aggregation with different BLER targets are conducted. Significant gain can be observed with enlarging the HARQ process number.

One source provided system level simulations for LEO=1200 km with 20% resource utilization, 16 and 32 HARQ processes, 15 and 20 UEs per cell, proportional fair scheduling, and no frequency re-use. The spectral efficiency gain per user with 32 HARQ processes compared to 16 HARQ processes depends on the number of UEs. With 15 UEs per beam, an average spectral efficiency gain of 12% at 50% per centile is observed. With 20 UEs per cell there is no observable gain.

The following options were considered with no convergence on which option to choose:
Option A: Keep 16 HARQ process IDs and rely on RLC ARQ for HARQ processes with UL HARQ feedback disabled via RRC
Option B: Greater than 16 HARQ process IDs with UL HARQ feedback enabled via RRC with following consideration. In this case, in the case of 16 or more HARQ process IDs, maintenance of a 4-bit HARQ process ID field in UE capability and DCI may be considered.

Alternatively, the following solutions may be considered for 16 or more HARQ processes keeping the 4-bit HARQ process ID field in DCI:
Option A: Keep 16 HARQ process IDs and rely on RLC ARQ for HARQ processes with UL HARQ feedback disabled via RRC
Option B: Greater than 16 HARQ process IDs with UL HARQ feedback enabled via RRC with following consideration. In this case, in the case of 16 or more HARQ process IDs, maintenance of a 4-bit HARQ process ID field in UE capability and DCI may be considered.

Alternatively, the following solutions may be considered for 16 or more HARQ processes keeping the 4-bit HARQ process ID field in DCI:
Slot number based

Virtual process ID based with HARQ re-transmission timing restrictions

Reuse HARQ process ID within RTD (time window)

Re-interpretation of existing DCI fields with assistance information from higher layers

One source also considered solutions where the HARQ process ID field is increased beyond 4 bits

With regards to HARQ enhancements for soft buffer management and stop-and-wait time reduction, the following options were considered with no convergence on which, if any, of the options, to choose:
Option A-1: Pre-active/pre-emptive HARQ to reduce stop-and-wait time
Option A-2: Enabling/disabling of HARQ buffer usage configurable on a per UE and per HARQ process
Option A-3: HARQ buffer status report from the UE

The number of HARQ processes with additional considerations for HARQ feedback, HARQ buffer size, RLC feedback, and RLC ARQ buffer size should be discussed further when specifications are developed.

The configurations (NR frame structure, NTN system, etc.) discussed above may be combined and applied in the contents described below, or may be supplemented to clarify the technical features of the methods proposed in the present disclosure.

Polarization Antenna

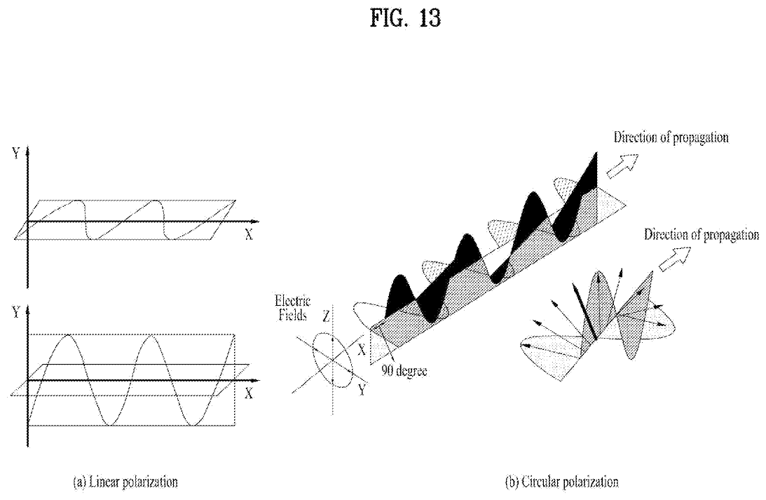

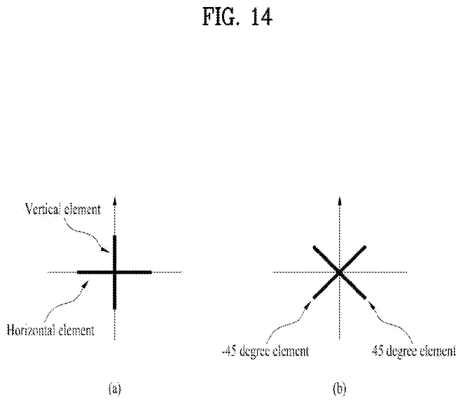

FIGS. 13 and 14 are diagrams for explaining polarization of an antenna.

In this document, the polarization (polarization) of an antenna means that the polarity direction of an electric field for the propagation direction of an electromagnetic wave is represented with respect to the ground surface.

Referring to FIG. 13, polarization is largely divided into two types: linear polarization and circular polarization.

The linear polarization is divided into horizontal polarization where the polarity of the electric field fluctuates in the direction horizontal to the ground surface and vertical polarization where the polarity of the electric field fluctuates in the direction perpendicular to the ground surface.

Referring to FIG. 13(b), the circular polarization has a shape in which the polarization plane moves in a spiral shape depending on time and propagation. A circular polarization signal may be generated as follows. For a cross-polarization antenna including vertical and horizontal antennas, the same signal is transmitted on each antenna, and a phase or time difference is given to the transmitted signals.

As shown in FIG. 13(b), a signal transmitted on the vertical antenna may be delayed by 90 degrees compared to a signal transmitted on the horizontal antenna. In this case, the polarization of a signal generated by combining the two transmitted signals rotates clockwise in the direction of propagation, which is referred to as right-handed circular polarization (RHCP). In contrast, when a signal transmitted on the vertical antenna is delayed by −90 degrees compared to a signal transmitted on the horizontal antenna, the polarization of a signal generated by combining the two transmitted signals rotates counterclockwise in the direction of propagation, which is referred to as left-handed circular polarization (LHCP).

If the time delay between a signal transmitted on the horizontal antenna and a signal transmitted on the vertical antenna has a value other than a multiple of 90 degrees, or when the magnitudes of signals transmitted on the two antennas do not match, the transmitted signals may have elliptical polarization.

Referring to FIG. 14(a), for a cross-polarization antenna composed of vertical and horizontal antennas, when the same signal is transmitted on each antenna, the polarization plane is tilted by 45 or −45 degrees. In this case, the polarization characteristics may be the same as or similar to those observed in a signal transmitted on a tilted cross-polarization antenna where vertical and horizontal antennas are tilted as shown in in FIG. 14(b).

Theoretically, for the cross-polarization antenna of FIG. 14(a), orthogonality is guaranteed between signals transmitted on the vertical and horizontal antennas so that there is no interference therebetween. That is, when the cross-polarization antenna of FIG. 14(a) is installed in a transmitter and receiver for communication therebetween, a signal transmitted on the vertical antenna of the transmitter is received only by the vertical antenna of the receiver, and a signal transmitted on the horizontal antenna of the transmitter is received only by the horizontal antenna of the receiver. Thus, there is no interference caused therebetween.

However, this phenomenon corresponds to a case where there is only a line of sight (LOS) link. In general, the polarization characteristics of a transmitted signal may change when the signal is reflected, refracted, or diffracted by a reflector or obstacle, and in this case, interference may occur between antennas. Generally, cross-polarization discrimination (XPD) is used as a metric for representing the degree (e.g., the degree of interference), where the XPD is defined as the ratio between power received with the same polarization antenna as that used by the transmitter and power received with the opposite polarization antenna. For a circular polarization signal, the rotation direction may change by reflection, refraction or diffraction.

Accordingly, by comparing the polarization characteristics of transmitted and received signals (i.e. a difference in received polarization angles, XPD, and/or polarization rotation directions), whether the signal is received through the LOS link with no reflection, refraction, or diffraction may be determined. In other words, the UE may obtain the polarization characteristics of a received signal by analyzing the characteristics of signals received on a cross-polarization antenna pair composed of vertical and horizontal antennas. Alternatively, the UE may receive only a signal having the same polarization characteristics as those of a transmitted signal to cancel a signal having modified polarization characteristics, which is received over multiple paths (i.e., NLOS link). Thus, the UE may accurately measure the propagation time of the LOS link.

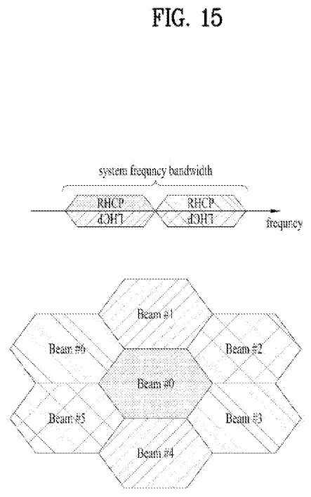

FIG. 15 is a diagram for explaining a scenario related to polarization reuse (see TR 38.821).

Referring to FIG. 15, a total of four orthogonal domains may be configured with frequency reuse 2 and polarization reuse 2. That is, one more polarization domain may be further used, compared to legacy LTE/NR where only frequency reuse is considered. In this case, there is an advantage that high flexibility may be provided in terms of network management.

Hereinafter, the polarization reuse will be described in detail.

Transmission and Reception Method Based on Circular Polarization in NTN

When the UE performs a RACH procedure, circular polarization domains (RHCP/LHCP) may be used for SSB-to-RO (RACH occasion) mapping (Proposal 1).

Specifically, the network may obtain which beam (corresponding to a certain SSB) the UE performs UL transmission from the SSB-to-RO mapping relationship. Here, a polarization domain may be further added as an orthogonal domain in addition to the time/frequency/sequence domain.

In other words, the UE may perform the RACH procedure further based on the SSB-to-RO mapping relationship where circular polarization or polarization information is reflected.

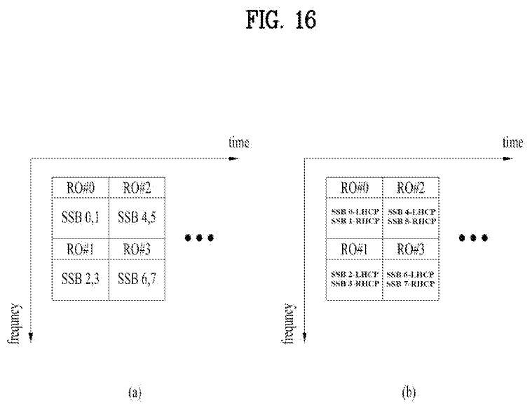

FIG. 16 is a diagram for explaining a method of matching an SSB and an RO based on circular polarization.

FIG. 16(a) shows an existing mapping relationship between ROs and SSBs. When a higher layer parameter “msg1-FDM” is 2, and when a higher layer parameter “ssb-perRACH-OccasionAndCB-PreamblesPerSSB” is 2, two SSBs may be mapped to one RO. In this case, the two SSBs mapped to the same RO may be linked to different sequence pools of preambles.

Referring to FIG. 16(b), two SSBs may be mapped to one RO based on the polarization domain. Specifically, when SSB 0 is transmitted based on LHCP, and when SSB 1 is transmitted based on RHCP, SSB 0 and SSB 1 may be mapped to one RO. In this case, preambles linked to SSB 0 and SSB 1 within the RO may have the same sequence pool, and two sequences may be identified based on the polarization domain such that the sequences are orthogonal to each other.

For example, an SSB with a low index/ID within one RO may correspond to LHCP, and an SSB with a high index/ID within the RO may correspond to RHCP. Alternatively, unlike shown in FIG. 16(b), an SSB with a low index/ID within one RO may correspond to RHCP, and an SSB with a high index/ID within the RO may correspond to LHCP. In other words, RHCP/LHCP may be configured for two SSBs within one RO depending on indices or IDs.

As described above, when RHCP and LHCP are mapped to the same RO, and when the same preamble sequence pool is shared for the same RO, a one-bit identifier for identifying RHCP and LHCP may be included in a random access response (RAR) related to the same RO in addition to a random access preamble identifier (RAPID) (for example, an RAPID is composed of 6 bits). In other words, when the same preamble sequence pool is shared for two SSBs in the same RO, the identifier for identifying RHCP and LHCP may be included in the RAPID. Alternatively, regardless of whether the same preamble sequence pool is shared for two SSBs in the same RO, the RAPID may include the identifier for identifying RHCP and LHCP.

Alternatively, half of the RAPID (e.g., 0 to 63) may be mapped to LHCP, and the other half may be mapped to RHCP. For example, the RAPID may be divided into odd and even numbers and then mapped to RHCP/LHCP. Alternatively, the RAPID may be divided into two parts: 0 to 31 bits and 32 to 63 bits and then mapped to RHCP/LHCP.

Alternatively, in addition to a method of explicitly indicating LHCP or RHCP, it may be predefined or preconfigured that when the receiving UE receives an RAR, the receiving UE (e.g., VSAT or Handheld) receives the RAR in a specific circular polarization direction for SSB reception.

Alternatively, for mapping between an SSB and an RO when the polarization domain is introduced, a mapping order between the SSB and {RO, preamble, polarization} may be predefined. That is, the mapping order between the SSB and {RO, preamble, polarization} may be predefined, and SSBs may be mapped according to the mapping order in ascending/descending order of SSB indices/IDs. In other words, the mapping order between the SSB and {RO, preamble, polarization} may be predefined or preconfigured in ascending/descending order of SSB indices.

Specifically, the mapping between {RO, preamble, polarization} (with the SSB) may be determined according to a first mapping order, a second mapping order, or a third mapping order, which will be described later. Hereinafter, it is assumed that polarization information is indexed with a predetermined index and the index for the polarization information is referred to a polarization index. For example, polarization index 0 may be predefined as the index for RHCP, and polarization index 1 may be predefined as the index for LHCP.

The first mapping order may be determined as follows: 1) preamble indices within a single RO->2) polarization indices within a single RO->3) frequency resource indices for frequency-multiplexed ROs->4) time resource indices for time-multiplexed ROs within a PRACH slot->5) indices of PRACH slots.

The second mapping order may be determined as follows: 1) polarization indices within a single RO->2) preamble indices within a single RO->3) frequency resource indices for frequency-multiplexed ROs->4) time resource indices for time-multiplexed ROs in a PRACH slot->5) indices of PRACH slots.

The third mapping order may have different polarization for the same preamble. Specifically, the third mapping order may be determined as follows: 1) polarization indices for a preamble index->2) preamble indices within a single RO->3) frequency resource indices for frequency-multiplexed ROs->4) time resource indices for time-multiplexed ROs in a PRACH slot->5) indices of PRACH slots.

As described above, SSB indices may be mapped with {RO, preamble, polarization} based on the first mapping order, the second mapping order, or the third mapping order.

Hereinafter, a case in which intra-frequency measurement is performed based on polarization (or circular polarization) in DL will be described (Proposal 2).

When polarization is used for the intra-frequency measurement, measurement results may vary depending on the polarization. Considering this point, the measurement may be configured/indicated to be performed by pairing cells that use the same polarization. Additionally/alternatively, a measurement gap may be configured between measurement of cells that use different polarization (Proposal 4). For example, information on the polarization (e.g., information on the measurement gap and/or paired polarization for each cell) may be indicated by an MIB or SIB1.

Alternatively, new quasi-co-location (QCL) may be introduced for smooth reception of a DL signal for each polarization. For example, when QCL-TypeE is introduced and configured for the UE, the UE may receive specific signaling (e.g., SSB, RS, etc.) according to a predetermined polarization method or a polarization method preconfigured and known to the UE.

The following QCL information may be configured in NR, and QCL-TypeE may be additionally defined.
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}
‘QCL-TypeE’: {polarization}

A polarization mode (e.g., RHCP, LHCP, or linear polarization) may be signaled for DL and/or UL, which may be indicated for each beam (e.g., SSB) during the initial access procedure. Alternatively, a separate polarization mode for initial access may be cell-specifically or beam-group-specifically indicated for each of DL and UL.

The corresponding value (e.g., polarization mode) may be updated or changed by higher layer signaling such as RRC/MAC-CE/DCI. Alternatively, a time at which the value is changed may be determined or configured to be applied after Y (msec or slots) from a time at which an RRC Reconfiguration Complete message is transmitted. If the value is indicated by MAC-CE or DCI, the time at which the value is changed may be determined to be applied after Y (msec or slots) from a time at which ACK information for reception of the signaling is transmitted. Alternatively, the time at which the value is changed may be determined to be applied after Y (msec or slots) from a time at which the update signaling is received.

The polarization mode may vary for each channel. A default polarization mode may be determined as a polarization mode related to a (lowest or highest) SSB index, a CSI-RS index, a PDCCH, a PUCCH index, BWP0, and/or CORESET0. In addition, the polarization mode may be indicated/configured for each beam/beam group as described above. In this case, signaling for changing the polarization mode for all beams may be redundant. In order to avoid the redundancy, a predefined rule may be determined, or a mapping pattern for a specific beam and the polarization mode may be predetermined by RRC. The mapping pattern may be changed by dynamic signaling such as MAC-CE or DCI.

HARQ feedback disabling may be supported for the NTN. In this case, enabling/disabling of a specific HARQ process (e.g., up to 32 processes) may be semi-statically configured. When HARQ feedback is disabled, it has an advantage of reducing latency that may occur due transmission and retransmission of HARQ feedback (ACK/NACK). This may be particularly effective in a system that operates based on a long round trip time (RTT) such as the NTN. However, since no ACK/NACK is transmitted for the corresponding process, it is difficult for the BS to estimate the reliability of a corresponding link, which becomes difficult to achieve performance enhancement.

In addition, NR may support dynamic BWP switching (up to four BWPs may be configured for each DL/UL, and one of the four BWPs may be configured). In this case, the BS may indicate to the UE the BWP or BWP switching based on DCI by considering the traffic load of the UE for each service. Thus, since it is desirable to perform the BWP switching to a link with high reliability, it may be determined that only BWP switching indicated by DCI of an enabled HARQ process is valid. That is, the BWP switching indication in DCI in the HARQ feedback disabling state may be regarded to be invalid.

Alternatively, for measurement gap enhancement, the BWP switching in the NTN may operate in conjunction with fast beam switching. For example, it may be considered to associate a specific SSB with a specific BWP and operate the SSB and BWP in conjunction with DCI-based BWP switching. In this case, it is necessary to monitor the channel state for smooth changing or switching to a target BWP (to be switched) other than an active BWP. In this case, the monitoring means measuring an RS (e.g., SSB or CSI-RS) of the target BWP. To effectively support the operation, a measurement gap may be configured for the BWP switching in the NTN. The NTN may have frequency fluctuation due to a high Doppler phenomenon caused by fast satellite speeds, unlike a conventional terrestrial node (TN). Considering this point, it is possible to perform re-synchronization necessary for monitoring and switching to the target BWP by configuring the measurement gap during the BWP switching.

In the NTN, the UE may obtain satellite orbit information from UE positioning based on the Global Navigation Satellite System (GNSS) and ephemeris information. In this case, if the location of the UE is capable of being known by the GNSS, a delay due to the distance between a specific satellite and the UE may be predicted/calculated. To this end, the serving gNB may provide the UE with information on a target cell (e.g., ephemeris information on a target satellite and/or location information on a target gateway). In this case, considering a time (e.g., round trip delay) required for a signal transmitted from the specific satellite to reach a specific user, the user may accurately predict and inform the gNB or a target gNB of information on a time (e.g., satellite-to-UE RTT) to be emptied to measure signals from the serving cell and/or target cell.

According to the above proposals, a method of using LHCP/RHCP, which are polarization orthogonal domains in circular polarization, may also be applied to linear polarization. That is, the above proposals may be applied or extended to identify linear polarization related to “V-slant/H-slant” or “+45 degrees slant/−45 degrees slant”.

It is obvious that each of the examples of the proposed methods may also be included as one implementation method, and thus each of the examples may be regarded as a kind of proposed method. Although the proposed methods may be implemented independently, some of the proposed methods may be combined (or merged) for implementation. In addition, it may be regulated that information on whether the proposed methods are applied (or information on rules related to the proposed methods) should be transmitted from the BS to the UE in a predefined signal (e.g., a physical layer signal, a higher layer signal, etc.). Higher layers may include, for example, at least one of the following functional layers: MAC, RLC, PDCP, RRC, and SDAP.

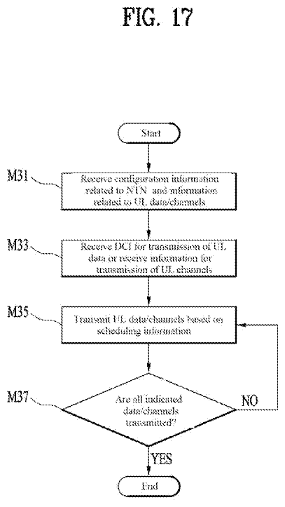

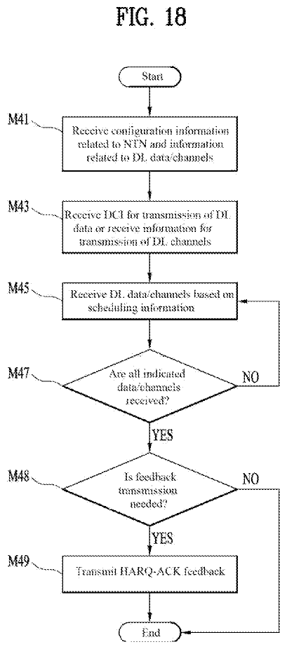

FIG. 17 is a flowchart illustrating a method for a UE to perform a UL transmission operation based on the above-described embodiments, and FIG. 18 is a flowchart illustrating a method for a UE to perform a DL reception operation based on the above-described embodiments.

The UE may perform NR NTN or LTE NTN transmission and reception of one or more physical channels/signals based on at least one of proposals 1 and 2 described above. Meanwhile, at least one step shown in FIGS. 17 and 18 may be omitted depending on circumstances or settings, and the steps shown in FIGS. 17 and 18 are only described for convenience of description and do not limit the scope of the present specification.

Referring to FIG. 17, the UE may receive configuration information related to an NTN and information related to UL data/UL channels (M31). Next, the UE may receive DCI/control information for transmission of the UL data and/or UL channels (M33). The DCI/control information may include scheduling information for transmission of the UL data/UL channels. Next, the UE may transmit the UL data/UL channels based on the scheduling information (M35). The UE may transmit the UL data/UL channels until all configured/indicated UL data/UL channels are transmitted. When all the UL data/UL channels are transmitted, the corresponding UL transmission operation may be ended (M37).

Referring to FIG. 18, the UE may receive configuration information related to an NTN and information related to DL data and/or DL channels (M41). Next, the UE may receive DCI/control information for reception of the DL data and/or the DL channels (M43). The DCI/control information may include scheduling information of the DL data/DL channels. The UE may receive the DL data/DL channels based on the scheduling information (M45). The UE may receive the DL data/DL channels until all configured/indicated DL data/DL channels are received, and when all DL data/DL channels are received, the UE may determine whether transmission of feedback information for the received DL data/DL channels is needed (M47 and M48). If it is necessary to transmit the feedback information, the UE may transmit HARQ-ACK feedback and, if not, the UE may end the reception operation without transmitting HARQ-ACK feedback (M49).

Although not shown in FIG. 18, the UE and BS may perform the RACH procedure. Regarding the execution of the RACH procedure, the general signal transmission/reception method in the wireless communication system described above with reference to FIGS. 1 to 9 may be used or referred to. For example, SSB-to-RO mapping may be performed in the RACH procedure according to the above-described method. The SSB-to-RO mapping may be based on the polarization domain. In addition, the UE may perform the following procedures after completing the RACH procedure.

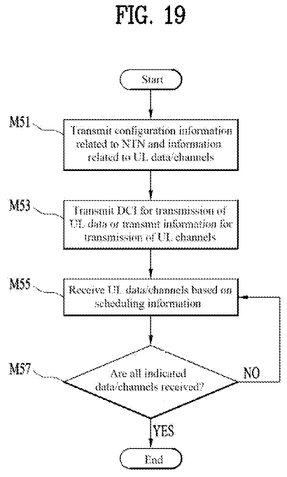

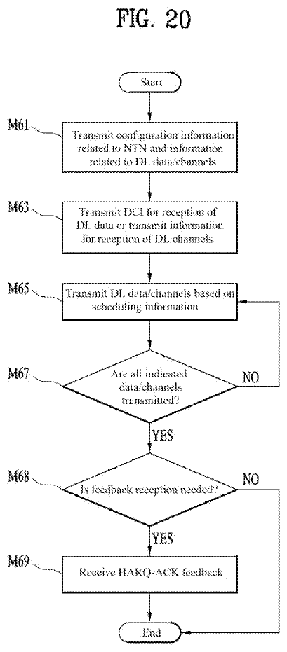

FIG. 19 is a flowchart illustrating a method for a BS to perform a UL reception operation based on the above-described embodiments, and FIG. 20 is a flowchart illustrating a method for a BS to perform a DL transmission operation based on the above-described embodiments.

The UE may perform NR NTN or LTE NTN transmission and reception of one or more physical channels/signals based on at least one of proposals 1 and 2 described above. Meanwhile, at least one step shown in FIGS. 19 and 20 may be omitted depending on circumstances or settings, and the steps shown in FIGS. 19 and 20 are only described for convenience of description and do not limit the scope of the present specification.

Referring to FIG. 19, the BS may transmit configuration information related to an NTN and information related to UL data/UL channels to the UE (M51). Next, the BS may transmit DCI/control information for transmission of the UL data and/or UL channels (to the UE) (M53). The DCI/control information may include scheduling information for transmission of the UL data/UL channels. Next, the BS may receive the UL data/UL channels (from the UE) based on the scheduling information (M55). The BS may receive the UL data/UL channels until all configured/indicated UL data/UL channels are received. When all the UL data/UL channels are received, the corresponding UL reception operation may be ended (M57).

Referring to FIG. 20, the gNB may transmit configuration information related to an NTN and information related to DL data and/or DL channels (to the UE) (M61). Next, the BS may transmit DCI/control information for reception of the DL data and/or DL channels (M63). The DCI/control information may include scheduling information of the DL data/DL channels. The BS may transmit the DL data/DL channels (to the UE) based on the scheduling information (M65). The BS may transmit the DL data/DL channels until all configured/indicated DL data/DL channels are transmitted, and when all DL data/DL channels are transmitted, the BS may determine whether reception of feedback information for the DL data/DL channels is needed (M67 and M68). If it is necessary to receive the feedback information, the BS may receive HARQ-ACK feedback and, if not, the BS may end the DL transmission operation without receiving HARQ-ACK feedback (M69).

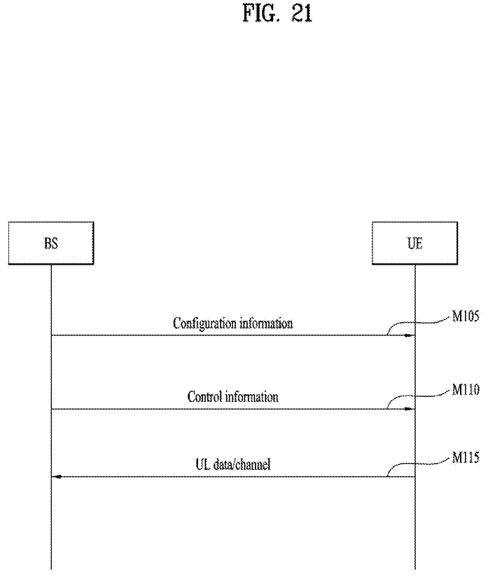

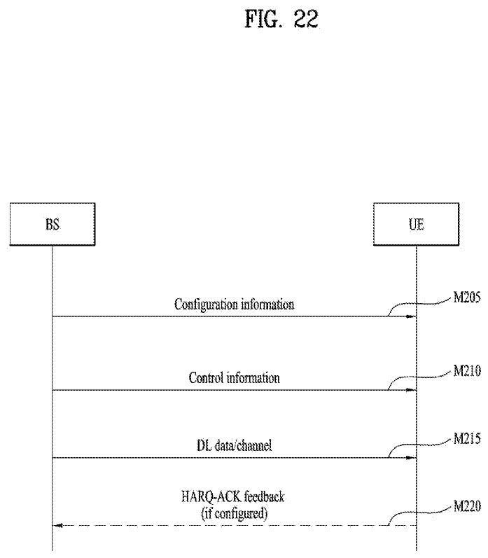

FIGS. 21 and 22 are flowcharts illustrating methods of performing signaling between a BS and a UE based on the above-described embodiments.

The base station and the UE may perform NR NTN or LTE NTN transmission and reception of one or more physical channels/signals based on the above proposal 1, and/or proposal 2.

Referring to FIG. 21, the UE and the BS may perform a UL data/channel transmission/reception operation and, referring to FIG. 22, the UE and the BS may perform a DL data/channel transmission/reception operation.

Referring to FIG. 21, the BS may transmit configuration information to the UE (M105). That is, the UE may receive the configuration information from the BS.

Next, the BS may transmit the configuration information to the UE (M110). That is, the UE may receive the configuration information from the BS. For example, the configuration information may be transmitted/received through DCI. Alternatively, the configuration information may include control information for UL data/UL channel transmission and reception, scheduling information, resource allocation information, HARQ feedback-related information (e.g., an NDI, an RV, HARQ process number, a DL assignment index, a TPC command for a scheduled PUCCH resource indicator, and/or a PDSCH-to-HARQ_FEEDBACK timing indicator), a modulation and coding scheme (MCS), and frequency domain resource assignment. Here, the DCI may be one of DCI format 1_0 and DCI format 1_1. Alternatively, the HARQ feedback-related information may be included in fields of the DCI.

Next, the BS may receive UL data/UL channels (e.g., a PUCCH/PUSCH) from the UE (M115). That is, the UE may transmit the UL data/UL channels to the BS. For example, the UL data/UL channels may be received/transmitted based on the above-described configuration information. Alternatively, the UL data/UL channels may be received/transmitted based on the above-described proposed methods. Alternatively, CSI reporting may be performed through the UL data/UL channels. The CSI reporting may be performed based on information such as RSRP/CQI/SINR/CRI.

Alternatively, as described above in the proposed methods (e.g., Proposal 1, Proposal 2, etc.), the UL data/UL channels may include feedback information (e.g., measurement results) for intra-frequency measurement. The feedback information (e.g., measurement results) may vary depending on polarization.

Referring to FIG. 22, the BS may transmit configuration information to the UE (M205).

Next, the BS may transmit the configuration information to the UE (M210). That is, the UE may receive the configuration information from the BS. The configuration information may be transmitted/received through DCI. Alternatively, the configuration information may include control information for DL data/DL channel transmission and reception, scheduling information, resource allocation information, HARQ feedback-related information (e.g., an NDI, an RV, HARQ process number, a DL assignment index, a TPC command for a scheduled PUCCH resource indicator, and/or a PDSCH-to-HARQ_FEEDBACK timing indicator), an MCS, and frequency domain resource assignment. The DCI may be one of DCI format 1_0 and DCI format 1_1.

Next, the BS may transmit DL data/DL channels (or a PDSCH) to the UE (M215). That is, the UE may receive the DL data/DL channels from the BS. The DL data/DL channels may be transmitted/received based on the above-described configuration information. Alternatively, the DL data/DL channels may be transmitted and received according to the above-described proposed methods. For example, the DL data/DL channels may include a CSI-RS, a DMRS, a PRS, a PDSCH, etc. The DL data/DL channels may be generated based on polarization. In addition, polarization information (e.g., RHCP/LHCP) may be included in sequence initialization of the DL data/DL channels.

Next, the BS may receive HARQ-ACK feedback from the UE (M220). That is, the UE may transmit HARQ-ACK feedback to the BS.

The BS may generically refer to an object that performs transmission and reception of data with the UE. For example, the BS may be a concept including one or more transmission points (TPs) or one or more transmission and reception points (TRPs). In addition, the TP and/or the TRP may include a panel or a transmission/reception unit of the BS. In addition, “TRP” may be replaced with expressions such as panel, antenna array, cell (e.g., macro cell/small cell/pico cell), TP, and BS (gNB). As described above, the TRP may be distinguished according to information (e.g., an index or ID) about a CORESET group (or CORESET pool). As an example, when one UE is configured to perform transmission/reception with a plurality of TRPs (or cells), this may mean that a plurality of CORESET groups (or CORESET pools) is configured for one UE. Such a configuration for the CORESET group (or CORESET pool) may be performed through higher layer signaling (e.g., RRC signaling).

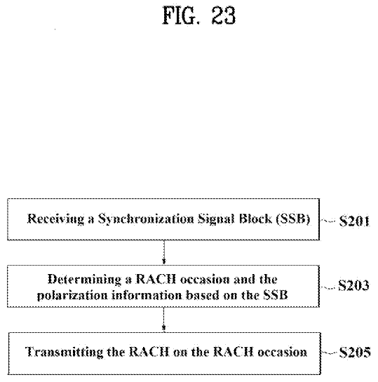

FIG. 23 is a diagram for explaining a method for a UE to transmit an RACH in consideration of circular polarization.

Referring to FIG. 23, the UE may receive an SSB from an NTN and/or BS (S201). The SSB may include a PBCH and a synchronization signal (SSS/PSS), which are information necessary for initial access to the NTN and/or BS. The UE may acquire system information while synchronizing with the NTN and/or BS based on the SSB. Alternatively, the SSB may be polarized in a rotation direction corresponding to polarization information and then transmitted. In this case, the polarization information may include information on linear polarization and information on circular polarization as described above. In addition, the circular polarization may include circular polarization rotating in the left direction and circular polarization rotating in the right direction.

Next, the UE may determine an RO to transmit the RACH for the initial access based on the index of the received SSB (S203). That is, the UE may determine the RO mapped to the index of the SSB from among a plurality of ROs. In addition, the UE may obtain the polarization information related to the RACH based on the index of the SSB. The UE may obtain information on a mapping relationship between SSB indices and polarization information in advance from the network. The UE may determine or obtain the rotation direction of the circular polarization associated with the index of the received SSB based on the mapping relationship. In other words, the UE may acquire or determine not only the RO but also the rotation direction of the circular polarization on the RO based on the SSB index.

Specifically, the UE may receive information on a preconfigured mapping order from the NTN or network. The UE may determine or obtain a mapping relationship between SSB indices and RACH resource indices and a mapping relationship between the SSB indices and polarization indices related to the polarization information based on the preconfigured mapping order. Information on RACH resources may include information on RACH frequency resource indices and information on RO indices. In this case, the UE may determine time and frequency RACH resources, polarization information, and a preamble sequence index matching with the index of the received SSB based on the following mapping relationship.

Regarding the mapping relationship between SSBs and RACH resources, the UE may determine or map polarization information (or circular polarization information), RACH frequency resources, and ROs in ascending or descending order of SSB indices. In other words, based on the preconfigured mapping order, the UE may map the SSB indices to indices related to polarization information (hereinafter, polarization indices), preamble sequence indices, and/or RO indices. In this case, the UE may determine or acquire an RO index, a preamble sequence index, and a polarization index corresponding to or associated with the index of the received SSB based on mapping results according to the preconfigured mapping order.

The SSB indices may be mapped in the above-described first mapping order. Specifically, the SSB indices may be mapped in ascending or descending order as follows: 1) preamble indices within a single RO->2) polarization indices within a single RO->3) frequency resource indices for frequency-multiplexed ROs->4) time resource indices for time-multiplexed ROs within a PRACH slot->5) indices of PRACH slots. That is, according to the first mapping order, the SSB indices may be first mapped to preamble sequence indices within one RO based on the preconfigured mapping order.

Alternatively, the SSB indices may be mapped in the above-described second mapping order. Specifically, the SSB indices may be mapped in ascending or descending order as follows: 1) polarization indices within a single RO->2) preamble indices within a single RO->3) frequency resource indices for frequency-multiplexed ROs->4) time resource indices for time-multiplexed ROs in a PRACH slot->5) indices of PRACH slots. That is, according to the second mapping order, the SSB indices may be first mapped to polarization indices and then mapped to preamble sequence indices within one RO based on the preconfigured mapping order.

Alternatively, according to the above-described third mapping order, different polarization information may be mapped to the same preamble. The SSB indices may be mapped in the above-described third mapping order. Specifically, the SSB indices may be mapped in ascending or descending order as follows: 1) polarization indices for one preamble index->2) preamble indices within a single RO->3) frequency resource indices for frequency-multiplexed ROs->4) time resource indices for time-multiplexed ROs in a PRACH slot->5) indices of PRACH slots.

In this case, the UE may obtain the polarization index corresponding to the index of the received SSB based on the preconfigured mapping order and then transmit the RACH based on the preamble sequence, the RO, and the polarization information corresponding to the index of the SSB.

Alternatively, the UE may receive an indication of any one of the first to third mapping orders from the NTN or BS through higher layer signaling. The UE may map the SSB indices to polarization indices, preamble sequence indices, and RO indices according to any one of the first to third mapping orders based on the indication (indicated through higher layer signaling such as DCI and RRC). The UE may acquire or determine the RACH resource (RO index, preamble sequence index, and polarization index) corresponding to the index of the received SSB based on the mapping result.

Next, the UE may transmit the RACH on the RO associated with the SSB index based on the polarization information associated with the SSB index (S205). That is, the RACH may be polarized in the rotation direction corresponding to the polarization information associated with the SSB index and then transmitted on the RACH resource (frequency, time, and preamble sequence) associated with the SSB index to the NTN. Here, the polarization information may include information on RHCP or LHCP. The UE may determine one rotation direction associated with the index of the SSB among RHCP and LHCP and transmit the RACH such that the RACH has the determined rotation direction.

Alternatively, the UE may receive an RAR from the NTN in response to the RACH. In this case, the UE may determine based on the RAR whether the RAR is associated with the RACH transmitted by the UE. The UE may further consider the polarization information related to the RACH to determine whether the RAR is in response to the RACH.

The UE may determine whether the RAR is in response to a RACH having specific polarization information based on an RAPID included in the RAR. For example, when the RO has the same preamble sequence pool according to the polarization information, the RAPID may additionally include a polarization identifier for the polarization information. In this case, the UE may determine whether the RAR is a signal in response to its own RACH based on the polarization identifier and the RAPID. Alternatively, the UE may determine or obtain the corresponding polarization information depending on whether the RAPID is an even or odd number.

Alternatively, the UE may control a polarization antenna to receive only an RAR having the polarization information included in the RACH and/or an RAR having the same polarization information as that included in the received SSB. For example, the UE may transmit the RACH such that the RACH has the direction of RHCP or may receive an SSB having the direction of RHCP or including polarization information on the direction of RHCP. The UE may control its polarization antenna so that the UE may receive the RAR only in the direction of RHCP. In this case, it may be unnecessary to identify the polarization information based on the RAPID in the RAR.

Alternatively, the UE may transmit a UL signal having the polarization information related to the RACH as a default (i.e., in the rotation direction of circular polarization). For example, when the polarization information associated with the SSB index is RHCP, the UE may transmit a UL signal having the polarization information corresponding to RHCP. Alternatively, the UE may be instructed to change the polarization information by the NTN through higher layer signaling such as DCI and RRC.

The UE may determine whether the RAR is in response to its own RACH by additionally considering the polarization information of the RAR as described above.

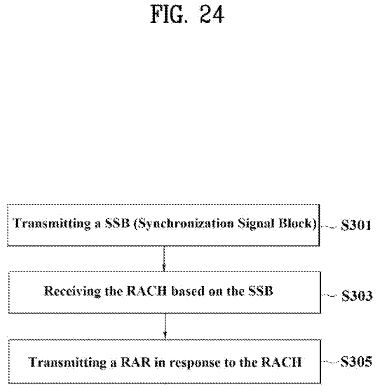

FIG. 24 is a diagram for explaining a method for an NTN to receive a RACH in consideration of circular polarization.

Referring to FIG. 24, the NTN may transmit an SSB to a UE (S301). The SSB may include a PBCH and a synchronization signal (SSS/PSS), which are information necessary for initial access to the NTN and/or BS. The SSB may be polarized in a rotation direction corresponding to polarization information and then transmitted. Alternatively, SSB indices may be associated with RACH resources on which a RACH is to be transmitted, and the SSB indices may be associated with polarization indices.

Next, the NTN may receive the RACH from the UE based on the SSB (S303). The NTN may receive the RACH on at least one RO among a plurality of ROs. The NTN may obtain or determine information on the SSB associated with the RACH based on a RACH resource on which the RACH is received. In addition, the NTN may determine or obtain polarization information related to the RACH based on the SSB.

Alternatively, the NTN may map the SSB indices to RACH resources (RACH frequency resources, ROs, preamble sequences, and/or polarization information) based on a preconfigured mapping order. Specifically, the NTN may map the SSB indices to RACH resource indices and obtain information on the SSB related to the received RACH based on the mapping relationship.

Regarding the preconfigured mapping relationship, the SSB indices may be mapped in the above-described first mapping order. Specifically, the SSB indices may be mapped in ascending or descending order as follows: 1) preamble indices within a single RO->2) polarization indices within a single RO->3) frequency resource indices for frequency-multiplexed ROs->4) time resource indices for time-multiplexed ROs within a PRACH slot->5) indices of PRACH slots.

Alternatively, the SSB indices may be mapped in the above-described second mapping order. Specifically, the SSB indices may be mapped in ascending or descending order as follows: 1) polarization indices within a single RO->2) preamble indices within a single RO->3) frequency resource indices for frequency-multiplexed ROs->4) time resource indices for time-multiplexed ROs in a PRACH slot->5) indices of PRACH slots.

Alternatively, according to the above-described third mapping order, different polarization information may be mapped to the same preamble. The SSB indices may be mapped in the above-described third mapping order. Specifically, the SSB indices may be mapped in ascending or descending order as follows: 1) polarization indices for one preamble index->2) preamble indices within a single RO->3) frequency resource indices for frequency-multiplexed ROs->4) time resource indices for time-multiplexed ROs in a PRACH slot->5) indices of PRACH slots.

Alternatively, the NTN may indicate one of the first mapping order to the third mapping order to the UE through higher layer signaling. Alternatively, the NTN may receive information on any one of the first mapping order to the third mapping order from the UE.

Next, the NTN may transmit an RAR including information related to the RACH (S305). The NTN may transmit the RAR including sequence information and polarization information related to the RACH. In this case, the RAR may include a RAPID for identifying the information related to the RACH. Alternatively, the RAR may be polarized in a polarization direction corresponding to the polarization information related to the RACH and then transmitted.

For example, when the same preamble sequence pool is used for polarization information on one RO, it is difficult to identify the polarization information based on the sequence information included in the RAR. In this case, the RAPID may additionally include a polarization identifier for the polarization information to indicate the polarization information on the RACH. Alternatively, the corresponding polarization information may be configured or determined in advance depending on whether the RAPID is an even or odd number.

Next, the NTN may receive a UL signal from the UE based on the polarization information related to the RACH and/or the polarization information related to the SSB. For example, when the polarization information associated with or related to the index of the SSB is RHCP, the NTN may receive a UL signal polarized by RHCP. Alternatively, the NTN may instruct the UE to change the polarization information for the UL signal through higher layer signaling such as DCI as described above.

As described above, the NTN transmits the RAR additionally including the polarization information as described above in order to inform the UE whether it is a response to the RACH transmitted based on specific polarization information.

Communication System Example to which the Present Disclosure is Applied

Although not limited thereto, various descriptions, functions, procedures, proposals, methods, and/or operational flow charts of the present disclosure disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

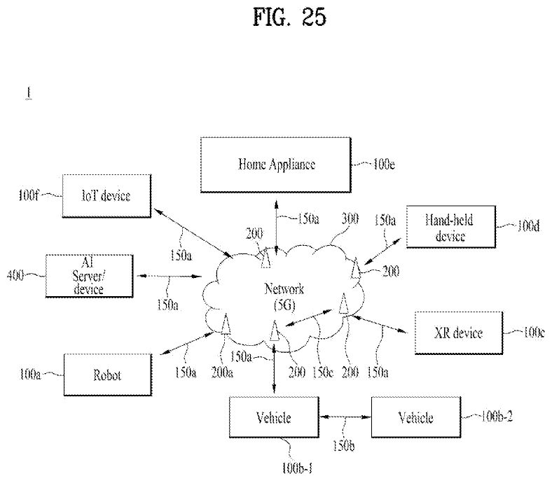

FIG. 25 illustrates a communication system applied to the present disclosure.

Referring to FIG. 25, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (JAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Examples of Wireless Devices to which the Present Disclosure is Applied

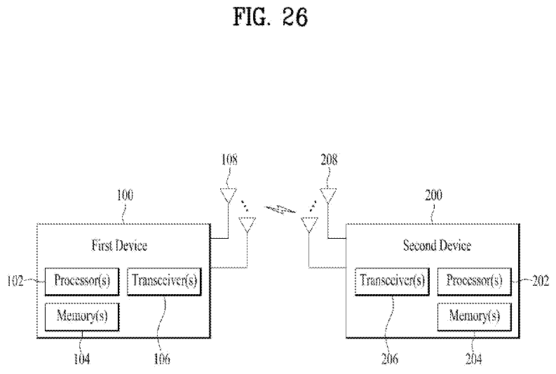

FIG. 26 illustrates a wireless device applicable to the present disclosure.

Referring to FIG. 26, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 25.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

According to an example, the first wireless device 100 or a UE may include the processor(s) 102 connected to the RF transceiver and the memory(s) 104. The memory(s) 104 may include at least one program for performing operations related to the embodiments described with reference to FIGS. 13 to 24.

Specifically, the processor(s) 102 may be configured to control the RF transceiver 106 to receive an SSB; determine an RO based on the SSB; obtain polarization information on a RACH based on an index of the SSB; and transmit the RACH with the polarization information.

Alternatively, there may be provided a chipset including the processor(s) 102 and the memory(s) 104. In this case, the chipset may include at least one processor; and at least one memory operably connected to the at least one processor and configured to, when executed, cause the at least one processor to perform operations. The operations may include: receiving an SSB; determining an RO based on the SSB; obtaining polarization information on a RACH based on an index of the SSB; and transmitting the RACH with the polarization information. In addition, the at least one processor may be configured to perform operations related to the embodiments described with reference to FIGS. 13 to 24 based on a program included in the memory.

Alternatively, there may be provided a computer-readable storage medium including at least one computer program configured to cause at least one processor to perform operations. The operations may include: receiving an SSB; determining an RO based on the SSB; obtaining polarization information on a RACH based on an index of the SSB; and transmitting the RACH with the polarization information. In addition, the computer program may include a program for performing operations related to the embodiments described with reference to FIGS. 13 to 24.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

A BS or an NTN may include the processor(s) 202, the memory(s) 204, and/or the transceiver(s) 206.

The processor(s) 202 may be configured to: control the transceiver(s) 206 or RF transceiver(s) 206 to transmit an SSB; and receive a RACH on an RO related to the SSB. The RACH may be received based on the RO and the polarization information related to an index of the SSB. In addition, the processor(s) 202 may be configured to perform the above-described operations based on the memory(s) 204 including at least one program for performing operations related to the embodiments described with reference to FIGS. 11 to 24.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of Application of Wireless Devices to which the Present Invention is Applied

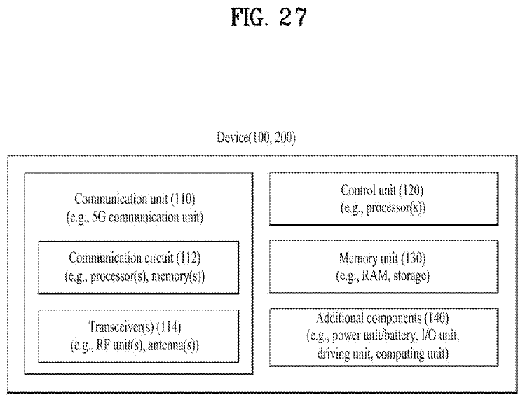

FIG. 27 illustrates another example of a wireless device applied to the present disclosure.

Referring to FIG. 27, wireless devices 100 and 200 may correspond to the wireless devices 100 and 200 of FIG. 26 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 26. For example, the transceiver(s) 114 may include the one or more transceivers 106 and 206 and/or the one or more antennas 108 and 208 of FIG. 26. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 25), the vehicles (100b-1 and 100b-2 of FIG. 25), the XR device (100c of FIG. 25), the hand-held device (100d of FIG. 25), the home appliance (100e of FIG. 25), the IoT device (100f of FIG. 25), a digital broadcast terminal, a hologram device, a public safety device, an MTC device, a medicine device, a fintech device (or a finance device), a security device, a climate/environment device, the AI server/device (400 of FIG. 25), the BSs (200 of FIG. 25), a network node, etc. The wireless device may be used in a mobile or fixed place according to a use-example/service.

In FIG. 27, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Here, wireless communication technologies implemented in the wireless devices (XXX, YYY) of the present specification may include LTE, NR, and 6G, as well as Narrowband Internet of Things for low power communication. At this time, for example, the NB-IoT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present specification may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present specification is at least one of ZigBee, Bluetooth, and Low Power Wide Area Network (LPWAN) considering low power communication, and is not limited to the above-described names. As an example, ZigBee technology can generate personal area networks (PANs) related to small/low-power digital communication based on various standards such as IEEE 802.15.4, and may be called various names.

The embodiments described above are those in which components and features of the present disclosure are combined in a predetermined form. Each component or feature should be considered optional unless explicitly stated otherwise. Each component or feature may be implemented in a form that is not combined with other components or features. In addition, it is also possible to constitute an embodiment of the present disclosure by combining some components and/or features. The order of operations described in the embodiments of the present disclosure may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present disclosure have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure.

### INDUSTRIAL APPLICABILITY

The above-described embodiments of the present disclosure are applicable to various mobile communication systems.

1.-15. (canceled)

16. A method of transmitting, by a user equipment (UE), a random access channel (RACH) based on polarization information in a wireless communication system, the method comprising:
receiving RACH configuration information including mapping information between a synchronization signal block (SSB) and a RACH occasion through RRC signaling;
receiving the SSB;
determining the RACH occasion mapped to the SSB based on RACH configuration information; and
transmitting the RACH on the RACH occasion,
wherein, based on the RACH occasion to which two or more SSBs are mapped, the UE obtains the polarization information related to the RACH based on an index of the SSB and transmit the RACH with the polarization information.

17. The method of claim 16, wherein the polarization information comprises information on linear polarization, right-handed circular polarization (RHCP), or left-handed circular polarization (LHCP), and
wherein a preamble sequence pool for the RACH occasion is configured to be identical for the linear polarization, the RHCP, and the LHCP.

18. The method of claim 16, wherein the UE receives a random access response (RAR) in response to the RACH, and
wherein the RAR includes a Random Access Preamble Identifier (RAPID) including a polarization identifier for distinguishing the polarization information.

19. The method of claim 18, wherein the RAPID is pre-mapped for each of right-handed circular polarization (RHCP) and left-handed circular polarization (LHCP).

20. The method of claim 16, wherein the UE is configured to receive a random access response (RAR) in response to the RACH, and
wherein a random access preamble identifier (RAPID) included in the RAR further comprises a polarization identifier for identifying the polarization information.

21. The method of claim 16, wherein the UE is configured to receive a random access response (RAR) in response to the RACH only in a polarization direction corresponding to the polarization information related to the SSB.

22. The method of claim 16, wherein the UE maps SSB indices to preamble sequence indices and polarization indices related to the polarization information based on a preconfigured mapping order, and obtains a preamble sequence index and a polarization index related to the index of the SSB based on mapping results.

23. The method of claim 22, wherein the SSB indices are first mapped to the preamble sequence indices within one RACH occasion based on the preconfigured mapping order.

24. The method of claim 22, wherein the SSB indices are first mapped to the polarization indices within one RACH occasion based on the preconfigured mapping order.

25. The method of claim 22, wherein the SSB indices are first mapped to the polarization indices for one preamble sequence index and then mapped to the preamble sequence indices within one RACH occasion based on the preconfigured mapping order.

26. A method of receiving, by a non-terrestrial network (NTN), a random access channel (RACH) based on polarization information in a wireless communication system, the method comprising:
transmitting RACH configuration information including mapping information between a synchronization signal block (SSB) and a RACH occasion through RRC signaling
transmitting the SSB; and
receiving the RACH on a RACH occasion mapped to the SSB related to the SSB based on RACH configuration information,
wherein, based on the RACH occasion to which two or more SSBs are mapped, the RACH is received based on the RACH occasion and the polarization information related to an index of the SSB.

27. A user equipment (UE) configured to transmit a random access channel (RACH) based on polarization information in a wireless communication system, the UE comprising:
a radio frequency (RF) transceiver; and
a processor connected to the RF transceiver,
wherein the processor is configured to:
control the RF transceiver to receive RACH configuration information including mapping information between a synchronization signal block (SSB) and a RACH occasion through RRC signaling,
control the RF transceiver to receive the SSB;
determine the RACH occasion mapped to the SSB based on RACH configuration information;
obtain based on the RACH occasion to which two or more SSBs are mapped, the polarization information on the RACH based on an index of the SSB; and
transmit the RACH with the polarization information.
